(19) United States
(12) Patent Application Publication
(10) Pub. No.: US 2013/0346274 A1
(43) Pub. Date: Dec. 26, 2013

(54) ELECTRONIC FINANCIAL TRADING PLATFORM WITH REAL-TIME DATA ANALYSIS AND REPORTING

(71) Applicant: Liquid Holdings Group, Inc., New York, NY (US)

(72) Inventors: Brian Ferdinand, Muttontown, NY (US); Robert Keller, Phoenix, AZ (US); Bruce Cooper, Fort Lauderdale, FL (US); Ioan Tandau, Cary, NC (US)

(73) Assignee: Liquid Holdings Group, Inc., New York, NY (US)

(21) Appl. No.: 13/842,210

(22) Filed: Mar. 15, 2013

Related U.S. Application Data
(60) Provisional application No. 61/663,858, filed on Jun. 25, 2012.

(51) Int. Cl. G06Q 40/04

(52) U.S. Cl. CPC G06Q 40/04
USPC 705/37

(57) ABSTRACT

An electronic financial trading platform includes: at least one application module; and a memory manager configured to provide normalized access to data content for the at least one application module, in which the memory manager includes a storage model configured to store references to the data content, an observer model configured to notify the at least one application module of changes to the storage model, and an automation model configured to trigger one or more sets of processes by the at least one application module in response to changes in the storage model.

### CROSS-REFERENCE TO RELATED APPLICATIONS

This patent application claims the benefit of U.S. Provisional Patent Application Ser. No. 61/663,858 filed on Jun. 25, 2012, and entitled “Financial Trading Platform

With Realtime Data and Reporting,” the entire contents of which are hereby incorporated by reference.

### BACKGROUND

Electronic financial trading platforms are computing systems that a user can use to place orders for financial products over an electronic communication network. The financial products can include items such as shares of stock, bonds, currencies, commodities and derivatives. In certain cases, the financial products are traded through intermediaries such as a brokers, investment banks or financial exchanges, among others. Fully electronic financial trading platforms allow electronic trading to be carried out by users that have access to a computer system and an electronic communication network such as the Internet or other communication network in contrast to partially automated floor-based trading systems that rely on electronics and open outcry and traditional floor-based trading system that rely on open outcry.

Electronic financial trading platforms may stream information to a user's computing system such as live market prices on which the user can trade. The platforms may also provide additional trading tools, such as charting packages, news feeds and account management functions. In certain cases, electronic financial trading platforms are designed to automatically trade specific strategies based on a user's previously defined trading position and information about financial products, such as price, volume, and trading activity, among other information.

Thus, the type of data utilized by an electronic financial trading platform can vary significantly based on the source from which the data is obtained and the purpose for which the data is used. In addition, the amount of data used in electronic financial trading platforms can be substantial due to the number and size of trades conducted by users of the system. Both the differences in data types being handled and the volume of data can negatively impact the speed at which trading information is provided to a user and at which trades may be completed. Moreover, the complexity and size of trading activity can inhibit production of information that advises a trader regarding his or her portfolio composition and/or risk position. For example, generating reports evaluating a trader's position at various points during the day can be a time-consuming process that slows down trading operations. Accordingly, reports regarding the trader's portfolio and risk positions are typically generated at the end of the trading day. As a result, the trader may need to make decisions based on dated information, leading to sub-optimal trading decisions. Such delays also provide opportunities for traders to evade supervision and engage in unacceptably high risk trading activity.

### SUMMARY

The present disclosure relates to an electronic financial trading platform with real-time data access and reporting. A financial trading platform can provide a user with a variety of tools for executing, tracking, and summarizing financial transactions and risk associated with those transactions. The platform can stay in communication with a network of data servers, all of which can receive and process data in real-time. Thus, financial analysis and reports can be generated for stakeholders in real-time and contemporaneously with trading activity, enabling better informed trading decisions and improvements in risk-monitoring.

Various aspects of the disclosure are summarized as follows. In general, in a first aspect, the subject matter of the disclosure may be embodied in an electronic financial trading platform that includes: at least one application module; a memory manager configured to provide normalized access to data content for the at least one application module, in which the memory manager includes a storage model configured to store references to the data content, an observer model configured to notify the at least one application module of changes to the storage model, and an automation model configured to trigger one or more sets of processes by the at least one application module in response to changes in the storage model.

Implementations of the system can include one or more of the following features and/or features of other aspects. For example, in some instances, the references to data content include a content object configured to provide a single normalized interface for multiple different data types. The multiple different data types may include at least two data types selected from the group consisting of: string, long, integer, double, boolean, and object.

In some implementations, the observer model is configured to, in response to a change in the storage model: review subscriptions to the storage model; and issue a notification of the change to application modules that are subscribed to the storage model. The change in the storage model may include a change in data content referenced by one or more cells of the storage model, in which the observer model is configured to, in response to the change in data content, issue the notification to application modules that are subscribed to the one or more cells of the storage model. The change in the storage model may include a change in meta-data associated with one or more cells of the storage model, in which the observer model is configured to, in response to the change in meta-data, issue the notification to application modules that are subscribed to the to one or more cells. The observer model may be operable to issue a content change notification and a meta-data change notification to the at least one application module in response to the change, in which the observer model is operable to synchronize the notifications.

In some implementations, the automation model is configured to trigger the one or more sets of processes according to a dependency graph. The dependency graph may include multiple nodes, each node corresponding to a different set of processes to be executed, in which the order of the nodes is non-cyclical, and in which execution of a set of processes represented by a first node in the graph begins after completion of a set of processes represented by a second node on which the first node depends. Execution of a set of processes represented by a third node in the graph may begin after completion of the set of processes represented by the second node, in which the sets of processes represented by the first and third nodes execute in parallel.

In some implementations, the at least one application module is configured to: examine one or more data elements to be transmitted; for each data element, select a minimum sized data format from a plurality of data formats that can losslessly represent the respective data element; and construct a message that contains the data elements in their respective minimum size data formats. The message may include a control block to specify a number of bits required to represent a data element in the message. The at least one application module may be configured to construct the message without delimiters between fields of the message. The message may include a message count field for specifying a number of sub-messages contained with the message, and a field count field for identifying a number of fields within each sub-message. Each sub-message may include at least one type field to identify a data type of a value contained in the sub-message, and at least one field identifier to identify a category of the value contained in the sub-message.

In some implementations, the platform includes one or more databases to store information relating to financial assets, in which the at least one application module is configured to: receive, from one or more data sources, financial market data, in which the financial market data comprises information about a plurality of financial assets; perform a real-time analysis of at least one of the financial assets based on the marketplace data; and generate information relating to results of the real-time analysis to the financial trading platform. The one or more databases may be further configured to store market information relating to at least one pre-defined event scenario, in which the at least one application module is further configured to: perform a simulation of a financial transaction based on the information relating to the at least one pre-defined event scenario; and generate a report based on a result of the simulation.

In some implementations, the at least one application module is further configured to receive, from a client device, a command relating to a financial asset, in which the command includes an instruction to execute a financial transaction including the financial asset, an instruction to simulate a financial transaction including the financial asset, or an instruction to generate a report based on the at least one financial asset.

In some implementations, the at least one application module is further configured to output one or more reports including the analysis of the at least one financial asset, in which the one or more reports are selected from the group consisting of: a financial asset profitability report, a financial asset performance report, a financial asset risk evaluation report, and combinations thereof.

In some implementations, the platform includes a reporting module configured to generate reports based on one or more financial assets, and a core trading module configured to execute and/or simulate one or more financial transactions based on one more financial assets.

In another aspect, the subject matter of the disclosure may be embodied in a computer-implemented method that includes: examining, in a first device, one or more data elements to be transmitted in a message; for each data element, selecting a minimum sized data format from a plurality of data formats that can losslessly represent the data element; and constructing a message that contains the data elements in their respective minimum size data formats.

Implementations of the system can include one or more of the following features and/or features of other aspects. For example, in some implementations, the message includes a control block to specify a number of bits required to represent a data element in the message.

In some implementations, the method further includes constructing the message without delimiters between fields of the message. The message may include a message count field for specifying a number of sub-messages contained with the message, and a field count field for identifying a number of fields within each sub-message. Each sub-message may include at least one type field to identify a data type of a value contained in the sub-message, and a field identifier to identify a category of the value contained in the sub-message.

In some implementations, the method further includes transmitting the message to a second device.

In another aspect, the subject matter of the disclosure may be embodied in a computer-implemented method that includes: storing, in a storage model, multiple content objects, each content object referencing a corresponding data value; receiving subscriptions to the storage model from one or more application modules; reviewing, in response to a change in the storage model, the subscriptions to the storage model; and issuing a notification of the change to an observer component of an application module that is subscribed to the storage model.

Implementations of the system can include one or more of the following features and/or features of other aspects. For example, in some implementations, the change in the storage model includes a change in data content referenced by one or more cells of the storage model, in which the method includes issuing the notification to an observer component of an application module that is subscribed to the one or more cells of the storage model.

In some implementations, the change in the storage model includes a change in meta-data associated with one or more cells of the storage model, in which the method includes issuing the notification to an observer component of an application module that is subscribed to the to one or more cells.

In some implementations, issuing the notification includes issuing a content change notification and a meta-data change notification to the observer component of the application module, in which the notifications are synchronized.

In some implementations, the method further includes triggering, in response to the change in the storage model, one or more sets of processes according to a dependency graph. The dependency graph may include multiple nodes, each node corresponding to a different set of processes to be executed, in which the order of the nodes is non-cyclical, and in which execution of a set of processes represented by a first node in the graph begins after completion of a set of processes represented by a second node on which the first node depends. Execution of a set of processes represented by a third node in the graph may begin after completion of the set of processes represented by the second node, in which the sets of processes represented by the first and third nodes execute in parallel

In another aspect, the subject matter of the disclosure may be embodied in a system that includes: a financial trading platform configured to receive marketplace data from one or more financial data sources, in which the marketplace data includes information about multiple financial assets; and a financial data analysis platform electronically and communicatively couplable to the financial trading platform, the financial data analysis platform being configured to obtain the marketplace data from the financial trading platform, perform a real-time analysis of at least one of the financial assets based on the marketplace data, and provide information relating to results of the real-time analysis to the financial trading platform.

Implementations of the system can include one or more of the following features and/or features of other aspects. For example, in some instances, the financial data analysis platform is further configured to perform the real-time analysis of the at least one financial asset based on a pre-defined event scenario.

In some cases, the real-time analysis includes a real-time financial risk analysis.

In certain implementations, the financial data analysis platform is configured to perform the real-time analysis by simultaneously executing multiple processing threads accessing a same portion of financial data.

In some implementations, the financial trading platform is further configured to: receive, from a client device, financial data source instructions; and select, based on the financial data source instructions, the financial data source from which to receive the marketplace data.

In some instances, the financial trading platform is further configured to output, in real-time, one or more reports that include an analysis of at least one financial asset, in which the one or more reports are selected from the group consisting of: a real-time financial asset profitability report, a real-time financial asset performance report, a real-time financial asset risk evaluation report, and combinations thereof.

In some implementations, the financial trading platform is further configured to create multiple issue groups, in which each issue group includes financial data relating to one or more of the financial assets, and in which the financial assets associated with each group are selected according to a feature from the group consisting of sector, industry, asset class, investor class, valuation, past asset performance, projected asset performance, volume, issuing entity, user-defined criteria, and combinations thereof. The financial data analysis platform may be further configured to perform a real-time analysis of the multiple issue groups and provide information relating to results of the real-time analysis of the multiple issue groups to the financial trading platform.

In another aspect, the subject matter of the disclosure can be embodied in a system that includes: a financial trading platform configured to receive market data from multiple data vendors, output the market data to a display, receive financial commands from a user, and execute the financial commands; a data system configured to receive information about the financial commands, store the information about the financial command, and make the information about the financial commands available to geographically disperse requesters in real-time; and a reporting module configured to receive the information about the financial commands from data system, and generate multiple reports that contain an aggregate of information about the financial commands in real-time.

Implementations of the system can include one or more of the following features and/or features of other aspects. For example, the system may include multiple financial trading platforms, in which each financial trading platform is assigned to a single user and at least some of the financial trading platforms are geographically separated from each other. Each financial trading platform may be configured to report information about the financial commands to the data system. The multiple reports may contain an aggregate of information about the financial commands of every financial trading platform.

In some implementations, the financial trading platform is further configured to receive a definition of an issue group, and execute the financial commands with reference to issue groups. In some cases, the data system is further configured t make the information about the financial commands with reference to issue groups available to geographically disperse requesters in real-time. In some instances, the reporting module is further configured to generate multiple reports that contain an aggregate of information with reference to issue groups about the financial commands in real-time.

In some implementations, the data system includes multiple servers that are communicably coupled together and with the financial trading platform, in which the data system caches a plurality of data structures from different servers to create a virtual data structure. The data system may be further configured to: perform a first set of processes on the virtual data structure within a first locking of the virtual data structure; and perform a second set of processes on the virtual data structure within a second locking of the virtual data structure.

The virtual data structure may include a composite data structure containing a multiple data elements. In some implementations, no two processes in the first set of processes affect the same data element of the virtual data structure, and no two processes in the second set of processes affect the same data element of the virtual data structure.

In some instances, every process in the second set of processes is dependent on at least one result of the processes of the first set of processes. In some implementations, the data system is configured to: examine data elements to be transmitted; for each data element, select a minimum sized data format from a plurality of data formats that can losslessly represent the respective data element; and construct a message that contains the data elements in their respective minimum size data formats. In some implementations, the message takes the format of (MessageCount) {(FieldCount) ControlNibbleBlock (((Type) Fieldld) FieldValue) . . . }, in which MessageCount is an unsigned long value whose width is established for a given message type, FieldCount is a count of fields in the message, ControlNibbleBlock specifies the representation for each element of the tuple in the message, Type is a long value representing a field type, FieldID is a long value representing a field identifier, and FieldValue is a value for a field.

In some implementations, the multiple reports include at least one report from the group consisting of: a multi-fund report showing multiple funds and multiple accounts within a fund; a multi-level hierarchical structure report showing an a hierarchical view of an entity, domain, fund, portfolio, strategy, and instrument structure; a multi-user permission driven report showing user permissions in the financial trading platform; a multiple product report that shows information from foreign exchanges, cash fixed income, equities, commodities, and interest rate swaps; an intraday portfolio valuation report that shows profitability of a portfolio; an intraday performance estimate report that shows a performance estimate; an intraday portfolio management report that includes including trade blotters, position reports, intraday and historical profitability, profit attribution analysis, volume reports by counterparty, financing reports and leverage reports; a risk reporting report showing risk statistics; and an inventor relations report showing investor-specific information.

In another aspect, the subject matter of the disclosure can be embodied in a machine-implemented method that includes: receiving marketplace data from one or more financial data sources, in which the marketplace data includes information about multiple financial assets; performing, using a data processing apparatus, a real-time analysis of at least one of the financial assets based on the marketplace data; and outputting information relating to results of the real-time analysis to a financial trading platform.

Implementations of the method can include one or more of the following features and/or features of other aspects. For example, performing the real-time analysis of at least one financial asset may be based on a pre-defined event scenario.

In some implementations, performing the real-time analysis includes performing a real-time financial risk analysis.

In some cases, performing the real-time analysis includes simultaneously executing multiple processing threads accessing a same portion of financial data.

In certain instances, the method further includes receiving, from a client device, financial data source instructions and selecting, based on the financial data source instructions, the financial data source from which to receive the marketplace data.

In some cases, the method further includes outputting, in real-time, one or more reports that includes the analysis of the at least one financial asset, in which the one or more reports are selected from the group consisting of: a real-time financial asset profitability report, a real-time financial asset performance report, a real-time financial asset risk evaluation report, and combinations thereof.

In some implementations, the method further includes creating multiple issue groups, each issue group including financial data relating to one or more of the financial assets, the financial assets associated with each group being selected according to a feature from the group consisting of sector, industry, asset class, investor class, valuation, past asset performance, projected asset performance, volume, issuing entity, user-defined criteria, and combinations thereof.

The method may further include: performing, using the data processing apparatus, a real-time analysis of the plurality of issue groups; and providing information relating to results of the real-time analysis of the multiple issue groups to the financial trading platform.

In another aspect, the subject matter of the disclosure can be encompassed in a machine-implemented method that includes: receiving market data from multiple data vendors; outputting to a display at least a portion of the market data; receiving financial commands from a user; executing the financial commands; receiving information about the financial commands; making the information about the financial commands available to geographically disperse requesters in real-time; and generating multiple reports that contain an aggregate of information about the financial commands in real-time.

Implementations of the method can include one or more of the following features and/or features of other aspects. For example, the financial commands may be received from multiple financial trading platforms, in which the multiple reports contain an aggregate of information about the financial commands of each of the financial trading platform.

In some implementations, the method further includes: receiving a definition of an issue group; executing the financial commands with reference to the issue groups; making the information about the financial commands with reference to issue groups available to geographically disperse requesters in real-time; and generating multiple reports that contain an aggregate of information with reference to issue groups about the financial commands in real-time.

In some instances, the method further includes: creating a virtual data structure; performing a first set of processes on the virtual data structure within a first locking of the virtual data structure; and performing a second set of processes on the virtual data structure within a second locking of the virtual data structure.

The virtual data structure may be a composite data structure containing multiple data elements, in which no two processes in the first set of processes affect the same data element of the virtual data structure, and no two processes in the second set of processes affect the same data element of the virtual data structure.

In some cases, each process in the second set of processes is dependent on at least one result of the processes of the first set of processes.

Making the information about the financial commands available to geographical disperse requesters in real-time may include: examining data elements to be transmitted; for each data element, selecting a minimum sized data format from multiple data formats that can losslessly represent the respective data element; and constructing a message that contains the data elements in their respective minimum size data formats.

The message may include a MessageCount field, a Field Count field, a ControlNibbleBlock field, a Type field, and a FieldID field, in which the MessageCount field includes a value representing a number of messages, the FieldCount field includes a count of fields in the message, the ControlNibbleBlock field includes a representation of each element of the tuple in the message, the Type field includes a value representing a field type, and the FieldID field includes a value representing a field identifier.

In some implementations, the multiple reports include at least one report selected from of the group consisting of: a multi-fund report showing multiple funds and multiple accounts within a fund; a multi-level hierarchical structure report showing an a hierarchical view of an entity, domain, fund, portfolio, strategy, and instrument structure; a multi-user permission driven report showing user permissions in the financial trading platform; a multiple product report that shows information from foreign exchanges, cash fixed income, equities, commodities, and interest rate swaps; an intraday portfolio valuation report that shows profitability of a portfolio; an intraday performance estimate report that shows a performance estimate; an intraday portfolio management report that includes including trade blotters, position reports, intraday and historical profitability, profit attribution analysis, volume reports by counterparty, financing reports and leverage reports; a risk reporting report showing risk statistics; and an inventor relations report showing investor-specific information.

The details of one or more implementations are set forth in the accompanying drawings and the description below. Other features and advantages will be apparent from the description, drawings, and claims.

### BRIEF DESCRIPTION OF THE DRAWINGS

FIG. 1 is a schematic diagram that illustrates an example of an electronic financial trading platform that is operable to handle data in real-time.

FIG. 2 is a diagram of an exemplary memory management system.

FIG. 3 is a diagram of an exemplary memory management system.

FIG. 4 is a graphical representation of a matrix.

FIG. 5 is a diagram of an exemplary dependency graph.

FIG. 6 is a diagram of an example of a relational memory management system that includes several different storage models.

FIG. 7A is a diagram showing a general form of three separate messages packed using string format.

FIG. 7B is a diagram showing the general form of messages packed according to dynamic sizing.

FIG. 7C is a diagram showing a message packed using string format, where the data type and order of the operands is known.

FIG. 7D is a diagram showing a message packed using dynamic sizing, where the data type and order of the operands is known.

FIG. 8 is an example intraday trading position and profit-loss report.

FIG. 9 is an example intraday trading position and realized versus unrealized profit-loss report.

FIG. 10 is an example report depicting periodic profit-loss.

FIG. 11 is an example report depicting equity holding by business sector.

FIG. 12 is an example commission report that depicts commission earned by counterparty.

FIG. 13 is an example report depicting net asset value, performance statistics, and cumulative returns.

FIG. 14 is an example report depicting daily performance based on value at risk.

FIG. 15 is an example monthly performance summary report.

FIG. 16 is an example report depicting investor metrics.

FIG. 17 is an example of a value at risk (VaR) report.

FIG. 18 is an example of an options risk report.

FIG. 19 is an example of a risk equivalent report.

FIG. 20 is a schematic diagram that shows an exemplary computing system for implementing an electronic financial trading platform.

### DETAILED DESCRIPTION

The present disclosure relates to electronic financial trading platforms capable of providing real-time data processing and analysis, and is divided into several sections. In the section titled “Electronic Financial Trading Platform,” the architecture of an exemplary financial trading platform is described. In the section titled “Memory Management System,” the operation of an exemplary memory management system for enabling real-time data processing in an electronic financial trading platform is described. In the section titled “Caching and Compression,” a description of an exemplary caching and compression process for use with a memory management system and other components of an electronic financial trading platform is provided. In the section titled “Electronic Financial Trading Platform Reports,” examples of user interfaces and reports that may be generated by an electronic financial trading platform are described. In the section titled “System Hardware,” an example of computer hardware on which an electronic financial trading platform may run is described.

For the purposes of this disclosure, real-time systems can be described as systems that operate with reference to an external time reference. For example, many electronic displays update at a rate of 60 Hz, and as such, real-time graphical data can be described as data that updates once every 1/60 seconds. In the field of metering and sensing, a real-time digital sensor can be described as one that responds to an input change with the same or lesser delay as an analog or mechanical counterpart.

Electronic Financial Trading Platform

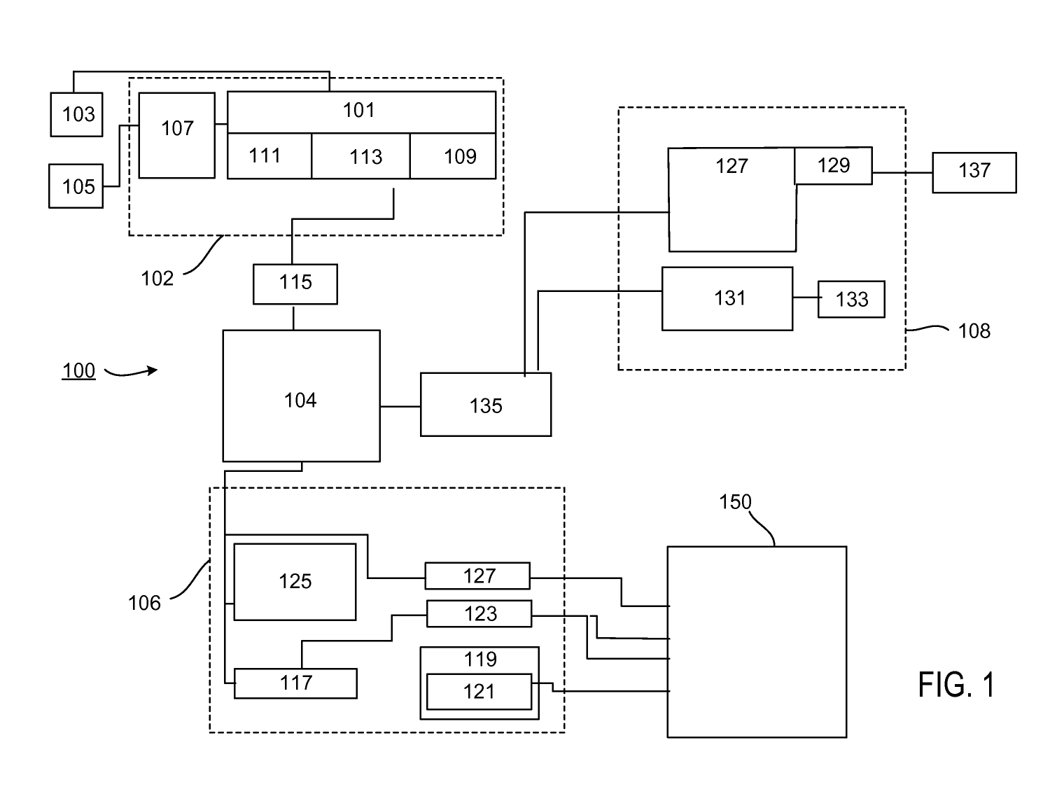

FIG. 1 is a schematic diagram of an exemplary electronic financial trading platform 100 for implementing financial trades and generating reports. Electronic financial trading platforms generally include computer systems that a user can use to place orders for financial products and assets including, but not limited to, shares of stock, bonds, currencies, commodities, interest rate swaps, and derivatives. The electronic trading platform 100 may or may not come with a number of additional features, such as live updating of market prices, news feeds, and automated trading capabilities.

The platform 100 shown in FIG. 1 includes multiple application modules and application sub-modules operable to collectively enable the financial transactions, and/or generate and output financial reports. The modules and sub-modules of platform 100 may operate individually or collectively on one or more server devices. Each module may include corresponding memory such as, for example, cache memory, on which data can be stored. In some implementations, the modules include hardware resources (e.g., processors, servers) dedicated to the process executed the module instead of or in addition to using resources shared among different modules of the platform 100. Each module may also include corresponding software instructions that, when executed, cause the module to perform one or more specific sets of processes related to that module. A user can interface with the platform 100 through a client workstation 150. For example, the client workstation 150 may store in memory one or more computer programs that allow a user to enter and send data (e.g., data relating to financial transactions and financial products) to and/or receive data (e.g., reports) from the platform 100 (i.e., to send data to and/or receive data from the one or more application modules of the platform 100). In certain implementations, the modules and at least one workstation 150 electronically communicate with one another over a network, such as a local area network, a wide area network, and/or over multi-connected communication networks, such as the Internet.

In the present example, platform 100 includes an accounting database module 102 that is operable to execute a set of processes for performing actions including, for example, collecting market data, trade data (including trading or risk position data), and/or accounting data from one or more sources. Market data includes information regarding trades (e.g., transactions executed by an exchange), best bid/offers (BBO) (e.g., the best available price or ask for a trade), quote books (i.e., a list of bids and offers at different price levels), market status (e.g., whether the market is open, closed, halted, or under extended hours), financial instrument status (e.g., whether trading on a financial instrument has halted or resumed, whether an instrument is an initial public offering, whether an instrument has been delisted). The market data can be provided either directly over a network from data sources including, for example, a financial exchange or a vendor of record affiliated with an exchange.

The market data can be obtained from the exchanges or vendors as soon as it is available. In addition or alternatively, the market data can include historical market data. Historical market data includes market data over specified periods of time (e.g., over the previous day, week, month, or year). Historical market data is not limited to historical data from a certain period in the past up to the present time but also may include specified periods of time in the past. In some instances, historical data may include market data associated with specific events in history including, for example, the substantial market declines that occurred in 1929, 1987 or 2008. In some cases, the historical data includes market data associated with specific non-financial asset related events in history, such as events involving military action, presidential elections, or natural disasters. Example vendors of market data include ACTIV, Reuters, Bloomberg, eSignal, Knight ITCH, and Interactive Data. The data received from the vendors and/or exchanges can include raw data (e.g., basic market information) or data that is derived from the raw data (e.g., data that includes analysis of raw data).

Trade data includes data and information about items such as a financial order, the execution of a trade, and trading position information. Trade data may be entered by a user operating the client workstation 150 (e.g., a user that enters an instruction to initiate a trade) or through an automated trading program operated by the platform 100. In some implementations, trade data is obtained from a clearing broker at certain times of the day for reconciliation or by an executing broker in real-time for tracking the trading activity. Trade data may be used by the platform 100 for real-time and after-market close reporting and reconciliation. Certain trades may take place internally to the platform 100 (e.g., trades such as cross orders that are internally executed). Examples of data sources (e.g., clearing and executing brokers) other than a user operating the client workstation(s) 150 include Credit Suisse and Knight. In some implementations, exchanges can provide that information as well if the platform is connected to an exchange over the network.

A trading/risk position in the context of financial products includes the amount of financial products (e.g., securities or commodities) held by a person, firm, or institution, and for the ownership status of a person's or institution's investments or the commitment to sell or buy a given amount of financial instruments. In an example, the accounting database 102 can electronically communicate with one or more sources such as market data sources 103 and/or broker data sources 105 to obtain market information regarding a financial product's features (e.g., price or volume). In some implementations, the accounting database 102 can obtain information regarding a user interacting with the platform 100 such as a trader operating the client workstation 150. User information can include, for example, account data, trading data (e.g., proposed trades and prior trades), and/or trading or risk position data. The accounting database 102 also can store information regarding financial transactions conducted using the platform 100 including, but not limited to, information relating to the time of one or more transactions, the volume of one or more transactions, and/or the parties involved in one or more transactions. The accounting database 102 tracks asset transaction executions, trading or risk positions, fees, interest components, journal entries, credits/debits, issue performance statistics, across one or more asset classes, currencies, brokers, geographic regions, investors, industries, user portfolios, funds, accounts within a fund, user financial asset strategies, and/or any applicable user defined criteria. The accounting database further can aggregates the foregoing information into one or more condensed reports for the user (e.g., a trader or a trader's supervisor/manager).

The data stored and/or manipulated by accounting database 102 may be sent directly to a destination, or may be aggregated, compressed, marshaled, or otherwise edited. The accounting database 102 can also generate new data structures for use by other modules and sub-modules of the system. The accounting database 102 may include any number of sub-modules. For example, the accounting database 102 can include: a Database Management and Reporting Server 101 for controlling input into the accounting database 102 and for storing procedures that calculate relevant statistics and values to be tracked and published; a file synchronization repository 107; an accounting report generator 109, which operates on top of the management and reporting server 101 and which produces publishable reports relating to data stored and processed by server 102; a database chronology scheduler 111 for setting schedules of activities for the accounting database to perform (e.g., one time activities or activities performed on a hourly, daily, weekly or monthly basis); and a mailer service 113 for emailing accounting reports to specified and permissioned users. The file synchronization repository 107 is configured to store information in a centralized manner that can be accessed by modules within the platform 100. For example, the file synchronization repository 107 may store information related to published reports that can be accessed for reading or editing by one or more file managers operating within the platform 100. Furthermore, the repository 107 may be used to provide a centralized storage and archival location for various applications operating on the platform 100. In some implementations, the repository 107 may be used to receive and store synchronization data from applications that communicate through a remote file system. The accounting database 102 may include other sub-modules as well.

Data stored or obtained by the accounting database 102 can be transferred to a central database cluster 104 through a partition sub-module 115. Because the data being in accounting database 102 may be received using different communication protocols and/or in different formats from vendor to vendor, the values contained in the data may vary in format. To handle the data properly, the platform 100 and modules operating on the platform 100 need to identify the source of the data, map the fields contained in the data to the internal fields of the platform 100, and format the values using the same formatting style, independent of the source from which the data originated. The partition sub-module 115 thus normalizes the data format prior to transferring the data to the cluster 104 so that other modules within the platform 100 may access the data from the cluster 104 in a single format.

As an example, the platform 100 may receive data corresponding to the execution of two different trades, in which information on the first trade is received from a first vendor in the form of a data message containing a trade ID field (e.g., information identifying the trade generated by the source location), a field including a calculation that determines the transaction price, a field containing the buyer and seller identification, but no field identifying the date of the trade. Information about the second trade may be received from a second different vendor in the form of a second data message containing a field identifying the date of the second trade, a field containing the transaction price, and a trade ID field, but no field specifying the parties to the trade. The two data sets may then be normalized to a single format by the partition sub-module 115 to have a trade ID field, a trade date field, a field identifying the parties to the trade, and a field identifying the amount of the trade, even though one or more of those fields may be empty based on the received data.

In some implementations, the data received by each vendor may be in a different format. Although shown as a separate module, the partition sub-module 115 may belong to the central database cluster 104 or, alternatively, may correspond to a part of the accounting database module 102. Furthermore, other application modules in addition to the accounting database module 102 may access the partition sub-module.

The platform 100 also includes a reporting module 106. The reporting module 106 is operable to use data from the accounting database 102 and the core trading module 108 to generate customized reports on trading activity. For example, in some cases, the reporting module is operable to execute a set of processes for performing actions including, for example, generating reports on current and/or past trading activity for individual traders or groups of traders. Additionally, the reporting module 106 is operable to generate reports on trading activity of selected financial products across different traders (e.g., trading activity in one or more specified industries). The reporting module 106 is operable to perform portfolio risk reporting in real-time. Reports can include, for example, risk statistics, performance returns, net asset values, decomposition of asset position, exposures, and/or risk versus reward graphs, among others. Reports can be prepared across one or more currencies, brokers, asset classes, classes of investors, regional instruments, industries, user portfolios, funds, accounts within a fund, user financial asset strategies, and/or any applicable user defined criteria. Some example reports are described later in the section titled “Electronic Financial Trading Platform Reports.”

These reports generated by reporting module 106 may use the most up to date data available from the accounting database module 102 and/or the core trading module 108 to produce reports in real-time. The trade data on which reports are generated may include information about execution of trades (“executions”). Executions are the actual trades that take place for a trade order. For instance, a market order of 1000 shares of a financial product may entail 3 separate executions: 200 shares at a first price; 500 shares at second price; and 300 shares at a third price. The executions may be obtained by the platform 100 through different channels. For example, in some implementations, the reporting module 106 may obtain data on executions from a trading application programming interface (API) that is notified whenever an execution of a particular financial instrument occurs. Alternatively, or in addition, a user such as a trader, may manually enter executions through the client workstation 150. The executions may have been generated on another trading application and would not be available through the trading API. In yet another implementation, a user may upload an execution file that contains executions performed outside of the trading platform 100.

In some implementations, the data on which the reporting module 106 relies is stored in the central database cluster 104. The reports may be in the form of a word processing document, a spreadsheet, figures, graphs, and/or charts that can be stored in a database on the platform 100 or in memory on the client workstation. In some implementations, the reports may output to a display unit coupled to the platform 100 or to a display coupled to the client workstation 150.

The reporting module 106 may include one or more sub-modules. For example, the reporting module 106 can include: a Reporting Yield Curve sub-module 117 that calculates yield curves for financial instruments; a Reporting AutoCalc sub-module 119 for updating the reporting module 106 with statistics and data in real-time (e.g., data from the central database cluster 104); a Reporting API sub-module 121 for providing one or more input channels for importation of executions; a Reporting Data Server sub-module 123 for managing market data for the Reporting Module 106 (i.e., since the reporting module 106 generates reports on executions in different instruments, correlated with market data on those instruments, appropriate data handlers are required for the different data sources); a Reporting Web Services sub-module 125 for providing a web portal that allows client workstations to access and view reports generated by the Reporting module 106 (e.g., risk reports) through an interface such as a web browser.

The reporting module 106 also can be configured to present real-time reports that include news data. News data includes both financial and non-financial related news and information. In general, news reports can be presented to a user through a display associated with the client workstation 150. Furthermore, news data can be used to trigger alerts and, in some cases, can be minded for meaning and information that aids in automated trading by the core trading module 108. Example data sources from which news can be obtained include Reuters, Bloomberg, Interactive Data, and NewsWare.

The reporting module 106 also can include a trade server 127 to receive financial commands from the client workstation 150 such as commands to implement trades of one or more financial products or implement simulations of trades of financial products. The commands received by the trade server 127 may be forwarded to the core trading module 108. In some implementations, information received by the trade server 127 and relating to proposed, simulated, or requested trades is stored in the database 104. The reporting module 106 may include other sub-modules as well.

The platform 100 also includes the core trading module 108. The core trading module 108 may be used by users (e.g., traders operating a client workstation) and other actors (e.g., an automated trading program running on the platform 100) to execute trading orders. The core trading module 108 is operable to execute a set of processes for performing actions including, for example, enabling real-time execution of order flow and trading/risk positional management by means of a user based permission and hierarchy enforced memory management system. That is, the memory management system organizes data in the core trading module 108 so that multiple processes can operate on the data at the same time without collisions. In certain implementations, real-time processing and analysis of order flow also is enabled through the use of a highly efficient data compression technique in which data is dynamically sized. The data management and compression techniques may be used by the core trading module 108 as well as other portions of the system (e.g., accounting database module 102 and reporting module 106) to analyze and/or provide information in real-time. Further information on the memory management system and data compression technique is included in the following sections entitled “Memory Management System” and “Caching and Compression.”

The core trading module 108 may include one or more sub-modules. For example, the core trading module 108 may include a brokering sub-module 127 that is operable to perform real-time risk checks of proposed and completed financial transactions. In some implementations, the brokering sub-module 127 is coupled to a trading application programming interface (API) 129. The trading API 129 is a portal into the brokering sub-module 127 that receives trade orders from third parties 137 (e.g., client work station 150 or other third party devices) that are external to the platform 100. For example, the third parties may include business entities that use the platform 100 as a broker, on which the third party implements its own internal logic on top of an application programming interface. In some implementations, the core trading module 108 includes a customized database 131, in which the database 131 stores pricing relating to bids, asks, and bid-ask spreads or information received from reporting module 106 and/or accounting database module 102.

The database 131 may be coupled to a replay/trading simulator sub-module 133 which is operable to simulate trades based on the data stored in database 131 without risking real profit/loss. For example, a user operating the client workstation 150 may be interested in how a set of trades would affect the user's overall risk position, and can issue an instruction (e.g., an instruction to purchase a specified number of financial products at a specified price) to the platform 100 to simulate the specified trades and report the predicted change in trader risk position. In another example, a user may use the replay simulator 133 of the platform 100 to simulate the market conditions for a specific day in history and train their trading skills under the specified market conditions. The simulation may use historical data obtained from the accounting database module 102. Alternatively, a user may utilize the simulator 133 to test their trading ideas for various market conditions to see how they would have performed under those conditions. An advantage of the replay simulator is that it captures market condition that may not be reproduced using present day data or randomized data. Using random data or attempting to recreate a specified market condition, in place of using historical data, may not capture the correlations between events, executions, and trading actions of the historical data and therefore may not be representative for real-life situations. The core trading module 108 may include other sub-modules as well.

The accounting database module 102 and core trading module 108 may handle different data type from one or more sources (e.g., from different brokers, exchanges or third party vendors). Instead of configuring the reporting module 106 to handle each of the different data types, the different data are instead normalized through partition sub-modules 115 and 135 and then saved in central cluster database 104. Similar to sub-module 115, sub-module 135 may also be formed as part of the central database cluster 104 or part of the core trading module 108. The partition sub-modules 115 and 135 also may operate in reverse: they can convert the normalized data stored in the central database cluster 104 back to the different data types handled by the accounting database module 102 and the core trading module 108. Thus, in operation, the platform 100 may be considered to be code-agnostic for the purpose of providing real-time data and reports to a user.

Operation of the Electronic Financial Trading Platform.

During operation of the electronic financial trading platform 100, a user operating the client workstation 150 may initiates a trade by instructing the client workstation 150 to send a command, such as a trading command (e.g., buy or sell of an asset) to the platform 100. This command is communicated to the core trading module 108 where the trading activity is initiated. Transaction data (e.g., data representative of executions, trading/risk positions, and/or order information) then may be communicated to the central database cluster 104. The accounting database module 102 and reporting module 106 access the central database cluster to obtain the transaction data and produce their respective accounting and portfolio risk reports. The accounting database module 102 also receives and distributes market data and broker data to the central database cluster 104. The accounting database module 102, reporting module 106 and core trading module 108 use the market data and broker data to facilitate trading operations, risk checks, statistical calculations, and data point value calculation.

A user operating the client workstation 150 receives information from the different modules (e.g., reporting module 106, accounting database module 102, core-trading module 108, trading simulator sub-module 133) such as, for example, portfolio updates (e.g., trading position, execution and order updates), real-time alerts (e.g., orders, brokering connections, data connections, application warnings, risk limit threshold warnings and alerts), portfolio risk reports, accounting reports, and/or engine back-testing results or simulation data from the trading simulator sub-module 133. The real-time alerts may include, for example, pop-up windows containing a message, changing colors, sound alerts, or other visual or audio indicator generated with the client workstation 150 to alert a user. The engine back-testing results may include statistical data collected after simulating proposed trades under historical market conditions or other pre-defined market conditions.

In some implementations, the electronic financial trading platform 100 may organize financial instruments according to user-created issue groups. These issue groups, and not the financial instruments themselves, may be the base logical unit used by the trading platform 100 for executing trades, tracking the user's activities, and providing real-time reports of the user's trading/risk position. For example, if a user creates an issue group 1 to contain 50% of a first financial instrument (e.g., stock A) and 50% of a second financial instrument (e.g., stock B), the trading platform 100 may track these two financial instruments in a bundle to facilitate reporting based on issue group 1, not just based on stock A and stock B. Additionally, a user may have the financial instrument in two or more issue groups. When reviewing a report listing the user's current trading/risk positions, for example, the trading platform 100 can display the value of each issue group separately, even though some contain the same stocks.

In some cases, a user may create an issue group to bundle similar instruments. These instruments may or may not be traded on the same execution venue (e.g., stock markets, commodity markets, derivative markets, futures markets, bond markets) and may or may not be the same or similar types of instruments (e.g., corporate bonds, stocks, derivatives, futures, commodities). For example a user may create a “North America Oil” group for North American oil instruments, a “European Oil” group for European oil instruments, and a “World Oil” issue group that contains North American, South American, and other oil instruments. In some cases, the user may create issue groups to embody a trading thesis. For example, the user may believe that company A will introduce a product that will eat into company B's market share. As such, the user may create an issue group that is short on company B's stock and long on company A's stock. The instruments may be of the same or differing asset classes. Another example might have a user create a group, or execute individually, buying or selling shares of stock of IBM while buying or selling European oil futures or swap contracts. These instruments may be executed on different exchanges globally or domestically. In some implementations, a user may create issue groups to bundle instruments according to the entity from which the instruments were issued, according to asset class, investor class, industry, fund, accounts within a fund, valuation, volume, past performance, and/or any applicable user defined criteria.

The issue groups may weight different instruments differently. This weighting may be used, for example, to reflect market share, a trader's intuition, or any other metric. Additionally, an issue group may contain other issue groups. Features described in this document may apply to both issue groups and/or individual instruments.

User data, including issue groups, may be shared with other users of the electronic financial trading platform 100. Each user of the platform 100, or an administrator with control over the user's data in the platform 100, may indicate some data to be shared with another user according to one or more permission schemes. The permission schemes may be based on well-known and documented permission schemes. One such permission scheme is the Unix-style permission scheme. In this scheme, each user may be designated to read (access and examine), write (read and modify), or execute (write and execute). This may enable, for example supervision of one trader by another or peer collaboration.

The trading platform 100 described herein is designed to interact with any applicable market to which the platform 100 can electronically communicate, using a variety of financial instruments, currencies, and data-streams from one or more different vendors either simultaneously or at different times. The foregoing information can be presented to a user on a display of a client workstation 150. In part, this is possible because the platform 100 is architected to use a distributed memory management system that is able to process large and diverse datasets in real-time. Real-time, in this context, generally means that the information is up-to-date enough to enable users to react to the market while the information they have is still useful. In addition to information for trading, this also includes dynamic reports that aggregate real-time information. In some cases, this means that the reports can be updated within a five or ten second window.

The availability of dynamic and/or real-time reporting on a single or multiple asset classes throughout the trading day can provide a number of advantages over systems that only create reports at the end of the trading day or systems that can only interact with a single asset class or region. For example, as the end of the trading day draws near, a trader (or a trader's supervisor or peer) can determine if they are satisfied with the risk, economic result, or concentration of their portfolio and/or trading position. Additionally, constant reporting can illuminate anomalies that do not show up at the beginning or end of the trading day. For example, a trader that maintains acceptable risk overnight but who has a habit (either innocently or in an attempt to skirt oversight) of assuming unacceptable intraday risk can monitor, or have monitored, his or her risk as it changes throughout the day.

### Memory Management System

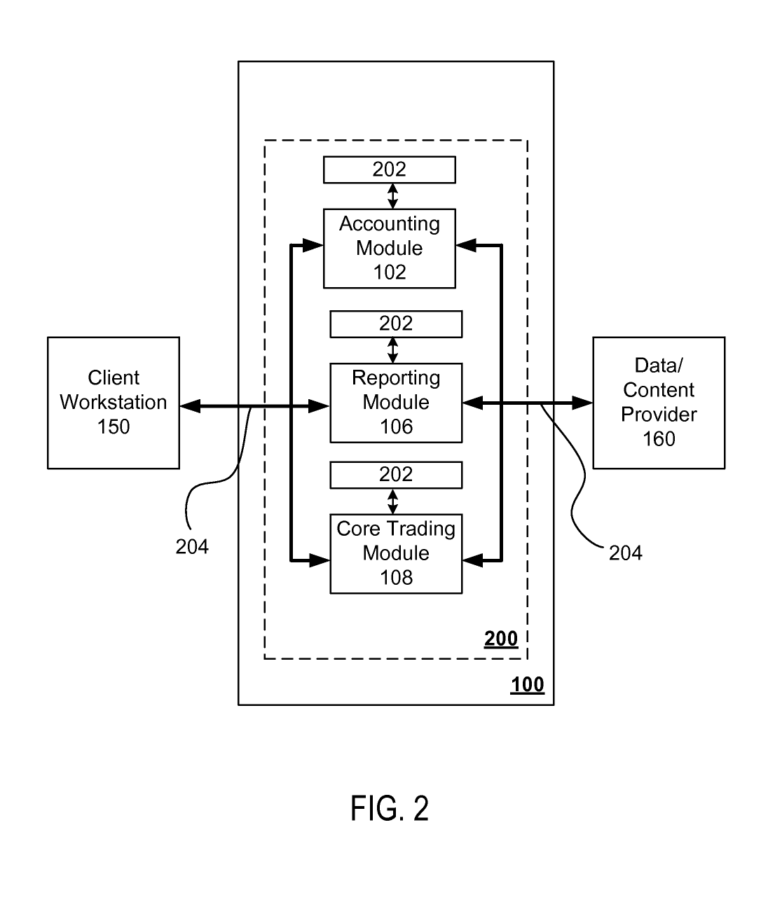

FIG. 2 is a diagram of an exemplary memory management system 200 (also called a “memory manager”) for use with an electronic financial trading platform, such as the platform 100 shown in FIG. 1. Though the discussion of the memory management system 200 below will be in the context of the platform 100, the memory management system 200 can be used with any applicable electronic financial trading platform. As shown in FIG. 2, the memory management system 200 operates across the electronic financial trading platform 100. In turn, the application modules of the electronic trading platform 100 (e.g., accounting database module 102, reporting module 106, and core trading module 108) operate on top of the memory management system 200. Each application module operating on the platform 100 may also include corresponding cache memory 202 for storing data. Alternatively, in some implementations, the modules can access data from a shared cache location. The memory management system 200 may provide memory management services to a single module of the platform 100 or multiple modules operating on the platform 100.

As shown in FIG. 2, data 204 passes through the platform 100 to and from one or more client workstations 150 and one or more vendors. Data 204 may also pass between the modules supported by the platform 100. The memory management system 200 provides a way to centralize and normalize the data that passes through the trading system 100 and cache the data for subsequent use. The modules of the electronic financial trading platform may cache the data locally so the modules can access the data directly at a later time. In some implementations, each module of the electronic financial trading platform is capable of obtaining data from the cache memory associated with the module, from cache memory associated with a different module, or from cache memory shared among two or more modules. The modules may also generate new data based on some of the cached data (e.g., transformed views of the data). That is, a module may require a transformed version of the data or require the data to be in a certain format that is unavailable from the data source. The module may generate the transformed data and cache the new data for direct access. For example, in some implementations, a vendor may provide price information for a financial product and size information (e.g., number of shares) for a financial product, but the module requires a value equal to price*size. The module may calculate this new value for generating a report or other purposes, and cache the new value, together with the underlying values on which the new value is based. In another example, a module may be programmed to provide to a display certain data (e.g., trading positions) for viewing by a user. The module may need to also display with a new value based on the data being displayed. Though the new values may not be stored with the original data itself in the cache, the module may calculate and output the new data directly from the cache data for the display. There are several reasons for caching data used by the modules. For example, when a module subscribes to a data source, the module may be restricted from requesting additional data until an update is available from the source. In such cases, the last data value should be used instead and caching allows the last data value to be readily available. Another reason is that, in some cases, there is considerable latency associated with data transfers to and from the database server (e.g., central database cluster 104). Thus, caching provides a reduction in access time for frequently accessed data.

In order to obtain the correct data for performing their specified operations, the different modules of the trading system 100 know from where in the platform 100 or elsewhere the data is to be provided and how to interact with other components in order to get the data. Rather than allowing each module to define its own method for accessing and modifying data (in which such methods may be incompatible with the methods of the other modules), the memory management system 200 provides a unified (normalized) way to access the data. By establishing a normalized method of access to the data, the memory manager may reduce latencies and extra processing overhead typically associated with the generation of objects for new data values and type-checking operations,

The memory management system 200 also employs a speed optimized storage and processing model, in which the time required by the modules/sub-modules for executing processes is substantially enhanced. As an example, the reporting module 106 may receive a request to publish a report. In order to create this report, the reporting module 106 may spawn three separate processes, each of which uses different data as input and output. Under the storage and process execution model described herein, the reporting module 106 may execute all three processes at once. In some implementations, this may represent a three-fold increase in efficiency over models of process execution that require processes to be executed in sequence. The storage and process execution model described herein may be used by any appropriate computer system employing the memory management system 200, including but not limited to the modules and sub-modules described with reference to FIG. 1. For example, general purpose computers and network servers may use this model of storage and process execution to facilitate multitasking of processes.

There are various different situations in which a module would use a memory manager to retrieve and store/cache data in the electronic financial trading platform. For example, in order to calculate profits and losses (“PnLs”) (e.g., using the accounting database module 102), trigger orders of financial products and/or alerts (e.g., using the core trading module 108), and present other statistics to a user (e.g., using the reporting module 106), real-time data is retrieved and stored from different data vendors, or from the platform 100 itself. Conceptually, the memory manager may store references to the data as a matrix with a symbol (e.g., a financial product name such as a stock symbol) as the row key and information about the financial product (e.g., the price and size) as the column keys (names). However, other arrangements for storing the data and/or references to the data are also possible.

In another example, a user may be interested in knowing his trading positions and the status of his orders and associated executions at all times. The trader may need to know what is his realized and unrealized PnL in order to make trading decisions. The accounting database module 102 or reporting module 106 would correlate the data from the price data example above with another matrix that has the financial product symbol as the row key and the order information (e.g., price, size, executed size, side) as the column keys. In this example, the financial product symbol may be the same for multiple rows, i.e., each row corresponds to a different trade for that particular financial product.

In another example, a user may want to automate his trading based on incoming news (e.g., news such as information regarding quarterly profit or loss of a particular company or information regarding world events that may have adverse or beneficial consequences for a particular type of financial product). The memory manager may index this data according to the financial product symbol that is referenced, the group/industry that is referenced or by different arbitrary tags added either by the data disseminator/provider or by the trader.

In another example, a trader may want to add another piece of data to an existing trade model, in which the data is generated based on different values in that model. For example, assume the trader wants to add a value called “Change” from the close in a price data model. He will need to have a source of closing prices (e.g., obtained externally from the platform 100) and he may be able to add a calculator (programmatically or through a graphical user interface of the client workstation 150) specifying that the value CHANGE=LAST−CLOSE, in which CLOSE is the closing price value and LAST is the value obtained from the external data source. The memory manager could, for example, add this CHANGE data to the price data model, which will trigger changes to model structure (the matrix, for example, may not have had the CHANGE field before the user added it, so the model will have to be modified to accommodate the new field). References to the data may be stored in one or more structures called storage models, described in more detail below.

General Memory Management

Before discussing parallel processing and normalization of different data types using the improved memory management system, it is useful to provide the following general discussion of memory management and relevant terms.

For the purposes of the following description of the memory management system 200, the models will be referred to in the context of the JAVA programming language. However, other object-oriented programming may be used to implement the memory management system as well. As explained above, a storage model used by the memory management system 200 may hold references to data, in which the references are conceptually stored as a matrix, though other storage models also may be used. For example, the storage model can be seen as a grid with rows representing symbols (e.g., financial products) and columns representing data fields (variable names, such as price or volume). The value of a variable is represented by a software object in this grid. Software objects include a “state” and a related behavior. A software object stores its state infields (also called “members,” “data members,” or “attributes” in some programming languages) and exposes its behavior through methods (functions in some programming languages). The object's fields may include variables or constants. Methods operate on an object's internal state and serve as the primary mechanism for object-to-object communication. Hiding internal state and requiring interaction to be performed through an object's methods is known as data encapsulation—a basis of object-oriented programming.

For the purposes of this disclosure, the software object stored in a storage model will be referred to as a “memory object.” The memory object is used as a standalone object. Whenever a module needs to access cells it has to first acquire an explicit lock on the memory object, change or read the cells that are of interest to it and then release the lock.

Access methods are functions specific to a software object that allow essentially direct manipulation and query of the object's members. Different object-oriented languages may provide different access modifiers, from a wide range to just public exposure. In general, a public modifier indicates that access to the members and methods of an object are available to anyone. Private modifiers indicate that the members and methods can only be accessed by the object itself. Inside an object, different qualifiers for members and methods may be mixed. In JAVA, there are four types of modifiers: public (fully accessible), protected (accessible from the class, package, and subclasses), private (accessible only from the class itself), and “<not specified>” (methods can only be accessed from the class itself and from the package).

As an example, consider the object “Person” with the following members: “firstName,” “lastName” and “age.” In cases where it is desired to protect the object from being directly altered by an external entity or user, the members are characterized as “private” and access methods are provided to control access to those members.

Two separate groups of “accessors” can access the memory object. The first group is represented by “writers” (also called “setters” [e.g., setFirstName(newName)]). Writers can either be a data source that pushes data from a provider to a memory object or a sub-module that performs calculations based on the values that already exist in the object. In general, writers are the first to be executed whenever changes to the data occur. The order of execution and the calculations themselves may be hard coded, which can limit the flexibility of the module operating on the electronic financial trading platform 100. The second group is represented by “readers” (also called “getters” [e.g., getFirstName( )]. Readers may include indirect methods (e.g. hasName( ) that do not return a member, but, rather, information about a member. Once the values have been set by the writers, the readers are notified of the changes.

Since primitive types (e.g., byte, short, int, long, float, double, boolean, char) cannot be used as values, the primitive types need to be wrapped in their corresponding JAVA objects. This is enforced by the nature of the software objects used in defining the storage structure and by the fact that primitive types cannot be used in containers (i.e., class, data structures or abstract data types for storing objects; containers include, e.g., sets, lists, arrays, or matrices). There are two adverse side effects that may result from this implementation:
i. Type boxing overhead—this is overhead (i.e., additional processing required by the memory management system) that occurs when a new software object needs to be created to wrap around primitive types.
ii. Overhead from explicit type checking—When using a container, it may be necessary to specify a base type for the elements stored by the container. However, only a single type can be specified. The base type/class for a JAVA object is “Object.” When extracting the “Object” from the container (such as a matrix), the extracted “Object” must be checked to ensure that it is the expected type. The extracted “Object” must then by type cast to the appropriate type so it can be used. Type checking is expensive, in terms of processing time, and may not be supported by all languages. Furthermore, if an extracted object is cast without checking, this may lead to an exception that can crash the processing thread, if not caught. Setting up blocks to capture exceptions may also be expensive in terms of processing throughput.

The implementation of the storage model in memory management systems may be slightly different from an actual matrix. For example, a HashMap may be used to map each symbol's name to a vector containing the values for the corresponding fields of the symbol. The storage model also may use maps between a field name and a field index (HashMap) and inversely between a field index and field name (the field array). When a value needs to be read or written for a symbol, the memory management system may be required to look up the vector for that particular symbol and locate the “cell” of the storage model using the field maps or using direct addressing if the index of the needed field is known.

The memory object plays the role of an observable object in an observer pattern. An observer pattern is a software design pattern that describes a relation between an object called an “observable” and one or more objects called “observers.” The observable object provides methods that allow observers to monitor its state (or to stop monitoring its state). The observers provide methods that can be used to update the observable object when a change in its state occurs. Observers are also referred to as “listeners.” Each module in the electronic financial trading platform may have one or more different observers for a particular storage model depending on the values the module requires. As an example, an observer that calculates PnL would be required to be an observer of both a price storage model (which contains data relating to financial product pricing) and of an order/position storage model (which contains data relating to orders/positions of a user) to obtain the current values and determine the new PnL. Both storage models may be referred to as “observables.” Whenever a change occurs in either observable, the observer component of the corresponding module in the electronic financial trading platform searches the storage model for the observable that has changed. Once the observables corresponding to the changed value have been located, the observer component then updates its calculations based on the changed values. Any information that provides insights on the state of an observed object is understood to be an “indicator.” An “indicator calculator” calculates values for other indicators based on the values provided by one or more indicators or events.

In general, the writers have more intimate knowledge than readers do of the memory object structure. Given the fact that the fields/indexes are predefined, the writers can reduce processing time by directly referencing fields using the field's index rather than name. This is not valid for readers which have to reference fields using the field name, and thus may perform a lot of unneeded dictionary look-ups.

Upon receiving a write signal from, e.g., a module in the trading platform, the writers are going to modify only the current symbol (i.e., the symbol for which the current signal was triggered). Specifically, a HashMap collects all the fields that have changed and their old values which can be read by writers and readers to decide what action to take, if any, based on the fields that have changed prior to them receiving control of the memory object. For example, if an observer has a number of rules that should only be evaluated if the value of certain field has changed, the observer will look those fields up in the collector map and, if any of the fields is found in the map, the observer will trigger an evaluation. Also, the event reaches the readers with the full list of changes so the event is treated as a single event not as a number of events equal to the number of fields that have changed. A memory manager that operates in this manner may have several drawbacks.

For example: 1) the memory manager may have a fixed number of predefined, hard coded fields; 2) the memory manager may have hard coded indicator calculators; 3) changes to properties (indicator/field values) are restricted to only one symbol per iteration (i.e., changes in one symbol cannot generate changes in a different symbol in the same step—this would require a more expensive workaround); 4) the memory manager may require a substantial number of dictionary lookups (the few direct referencing cases happen because of the fixed order of the indicators); 5) calculations are generally performed for every cell of the matrix, even if the resulting values are not needed; and 6) all of the indicators are required to be calculated in one iteration).

An Improved Memory Management System

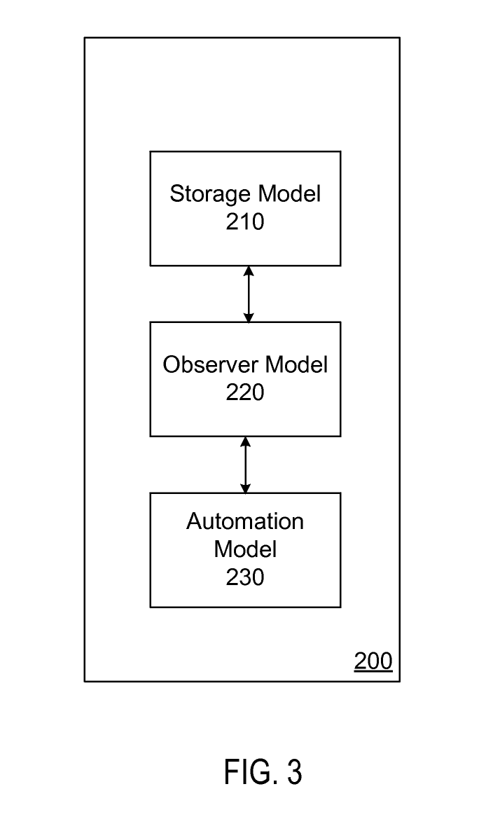

An improved memory management system can be obtained that overcomes the downsides discussed above with respect to standard memory management systems. The improved memory management system may be understood as a composition of three separate models: a storage model 210, an observer model 220, and an automation model 230. FIG. 3 is a diagram of an exemplary memory management system 200 including the three models.

The storage model 210 is an inert data structure that provides a layout for the data (meta-data), a content description (content) and access methods. The storage model 210 contains references for the application modules to locate data content in the platform 100. The references stored by the storage model 210 include content objects having a single normalized interface for different data types.

The observer model 220 includes an observer pattern construct that allows observers to watch activities that affect the storage model 210. That is, the observer model 220 is configured to issue notifications to particular observers upon changes to the storage model, depending on the observers' subscription to the storage model. Specifically, one or more application modules may subscribe to a storage model 210 (e.g., an application module registers an observer component with one or more rows, columns or cells of the storage model). When there is a change in one or more of the cells of the storage model (e.g., a change in the referenced value or a change in the storage model structure itself), the observer model 220 reviews the subscriptions to determine if the application modules should be notified of the change. If the observer model 220 determines that change is relevant to the subscription, the model 220 notifies the corresponding observer component of the application module of the change.

The automation model 230 is configured to trigger execution of one or more sets of processes from the application modules or other components upon specified changes in the content referenced by the storage model or when there are changes in the storage model itself The sets of processes can include calculator functions specific to the application modules or specific to other components of the platform 100. The automation model 230 includes different rules and constructs that allow for the definition of content providers.

As shown in FIG. 3, the models may share data with one another and thus are not independent. Instead, each model may contain information that is not required for their functionality but that is required for integration with the other models.

In the memory management system 200, various changes to the previously described memory management model are implemented to optimize the real-time handling of data. That is, the memory management system 200 is configured to optimize data access and predictability of operations in order to increase throughput of the modules running on the electronic financial trading platform, thus providing improved real-time responsiveness. Multiple features of the memory management system 200 enable the optimization of data access and improved real-time responsiveness.

For example, the memory management system 200 employs memory objects having a single normalized interface for each data type, in which the interface contains calls to different primitive types. By using a single normalized interface for memory objects, boxing/autoboxing for computations may be avoided. That is, instead of having to extract a primitive value from an object, perform a calculation, and then box the new value from the calculation into a newly created object that will be stored as a new value, the new value may be stored in the same primitive type of the original object. Thus, fewer operations and allocations are required, increasing the system throughput. Moreover, since fewer objects need to be created and released, the garbage collector does not need to be accessed as often, which in some implementations may lead to less instances of system freezes.

The memory management system 200 also does not need to check with a compiler whether the primitive type to be updated is correct. Instead, because the interface to the object contains calls to the different primitive types, a value of the existing object can be updated directly. Thus, the potentially time-consuming operation checking primitives can, in certain implementations, be avoided. Furthermore, the memory management system eliminates the requirement to evaluate each object, whether or not the values contained in the object are required for a module to perform a calculation. Instead, the automation model 230 of the memory management system 200 triggers operations by the modules or sub-modules (through observer components) when changes occur in the cells of the storage model to which the modules or sub-modules are registered. The memory management system 200 further employs a dependency manager to establish a dependency tree between observer components of the modules, so that the calculators or other components of the modules are triggered in a specific order based on their dependency and output. The dependency tree thus optimizes the execution of operations among the modules and allows the simultaneous parallel execution of processes on different data. Further details of the different models of the memory management system are described as follows.

Storage Model

As noted above, the storage model 210 is an inert object that can be read from or written to, much like any memory device (either software or hardware) and is the structure that defines the meta-data, the content and the access methods. Meta-data associated with the storage model 210 describes the data layout of the storage model (e.g., how fields are arranged in the storage model and properties of those fields). The meta-data exposes an internal structure for identifying where information is stored and external access methods that allow applications to dynamically change the meta-data information (e.g., by deleting/adding fields or changing fields' properties). For example, with respect to price data for a particular financial product, the storage model may be an array whose entries each represent a different 3-element array: [symbol, price, size]. The meta-data includes information regarding the keys (e.g., symbol in this case), how to find the keys and how to find the values for a given key. If a user or program adds a new field (e.g., CHANGE field indicating a change in price from the last available price) to the array, this requires making structural changes to the array. For example, the number of rows may stay the same, but each row will be expanded to a 4-element array: [symbol, price, size, change]. The meta-data is updated to take the new field for “change” into account. Adding another symbol will make a structural change in the main array as array will need to expand to allow for a new entry. This means that the meta-data needs to be updated to account for the new entry.

The content object describes the structure that holds each value. It exposes access methods that allow an external application to change values in the storage model. Normally, content objects will have information regarding the content type, the value the content holds, the previous value the content held, if there was a change, subscription methods (for tracking changes in the content) and access methods. The meta-data and the content model are encapsulated in the storage model 210, which acts as a proxy for the meta-data and content. Access methods are functions specific to an object as described above. The access methods in the storage model 210 forward control to the methods of the encapsulated objects. The access methods also offer simplified access to the underlying structures in a combined fashion. That is, since the content and meta-data are encapsulated by the storage model 210, a user only needs to interact with a single interface that provides access to both the content and the meta-data. Access to the values in the storage model 210 are be guaranteed constant time, i.e., the time it takes an operation to complete is not dependent on the length of the structure (i.e., the storage model) being processed.

A basic change in the layout of the storage model 210 from standard memory management systems is that instead of using a logical matrix with a map based implementation for the rows, an actual matrix is employed. This exposes index based addressing for the columns as well as for the rows, which were previously represented as HashMap entries.

It should be noted that JAVA doesn't have support for matrix structures. Instead, JAVA utilizes either arrays of references to arrays or arrays large enough to hold all the elements of the matrix, in which a mathematical formula is used to map the two dimensional matrix onto the array. The latter option is usually slower than the first and less flexible to work with. The fast and flexible solution is the array of references to arrays. The more useful alternative to arrays are ArrayListS since they are built on top of arrays and offer all the useful methods that the simple array type do not offer, like automatic resizing to fit the content. An advantage of using arrays of references also is that the resizing occurs either for the arrays of references or for each array referenced in that array. This means that resizing the matrix will require either a small array resize or a number of smaller resizes which is more memory friendly than the alternative of swapping one huge memory block and keeping large amounts of memory occupied during the resize. The memory penalty for over-resizing can be overcome by shrinking the arrays to fit the content on the spot or every once in a while if it is decided that it is an issue.

Multiple different instances of the storage model may be implemented in the memory managements system. For example, a storage model instance may include a price storage model that contains data relating to financial product pricing, or an order/position storage model that contains data relating to orders/positions of a user. Other storage model instances also may be defined.

The following declarations/statements correspond to the generic information required to define the matrix structure. For example, the statement:
Matrix<ROWCLASS,COLUMNCLASS,CONTENTCLASS
   shows the generic declaration that can be used for creating a matrix abstract class, in which “ROWCLASS” is the class of the row identifier, “COLUMNCLASS” is the class of the column identifier, and “CONTENTCLASS” is the generic class container for the cell value.

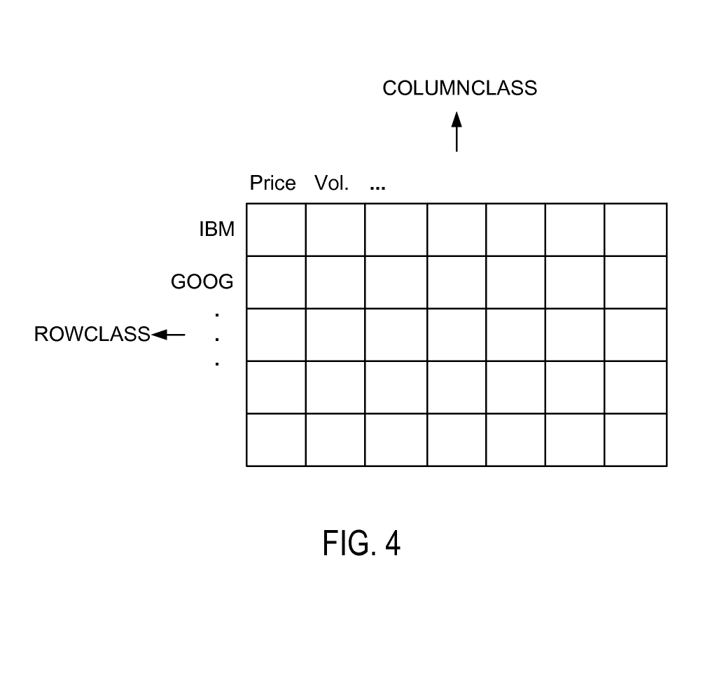

A graphical representation of the matrix as it results from the declaration above is shown in FIG. 4. Each row is identified by an instance of the ROWCLASS class. Similarly, each column is identified by an instance of the COLUMNCLASS class. As shown in the example of FIG. 4, the matrix may have m rows and n columns, in which the class for rows corresponds to different financial products (e.g., stock symbols) and the class for the columns corresponds to different aspects of the financial products such as price and volume. Each cell of the matrix represents the content class. The structure used in the model would be incomplete without the member methods. The two types of member methods are meta-data methods and content methods.

To retrieve the index of a given row or column, internal mappings may be set between the row/column and the corresponding index as set forth in the example below:
i. mapRowIndex:HashMap<ROWCLASS, Integer>
ii. mapIndexRow:ArrayList<ROWCLASS>
iii. mapColumnIndex:HashMap<COLUMNCLASS, Integer>
iv. mapIndexColumn:ArrayList<COLUMNCLASS>

The public access methods for retrieving the mapping may be set forth as shown in the following example:
i. getRowIndex(row:ROWCLASS): int
ii. getRow(index:int): ROWCLASS
iii. getColumnIndex(column:COLUMNCLASS): int
iv. getColumn(index:int): COLUMNCLASS

Index retrieval methods would return −1 if they fail to find a mapping, otherwise they would return the index of the given row/column. The row/column retrieval methods return either the equivalent index or null if there's no such an index.

The following list shows examples of access methods for altering meta-data:
i. addRow(row:ROWCLASS): boolean
ii. removeRow(row:ROWCLASS|index:int): boolean
iii. addColumn(column:COLUMNCLASS): boolean
iv. removeColumn(column:COLUMNCLASS index:int): boolean

The ‘|’ sign in the methods represent an alternate implementation. Once a column or row has been inserted, an index exists for the column or row. Thus, the column or row may be removed using its corresponding index reference.

The actual content holder is the object whose layout is dependent on the meta-data and its declaration may be set forth as shown in the example below:
i. matrix:ArrayList<ArrayList<CONTENTCLASS>>

The two access methods for the content may be set forth as shown in the example below:
i. getContent(rowindex:int|row:ROWCLASS, columnindex:int|column:COLUMNCLASS): CONTENT
ii. setContent(rowindex:int|row:ROWCLASS, columnindex:int|column:COLUMNCLASS, content: CONTENT): CONTENT

The “setContent” method sets a new content for the given cell and the “getContent” returns the old content.

The foregoing declarations/statements correspond to the information for defining the matrix structure, which forms the bases for the storage model 210.

The storage model 210 follows the same basic matrix implementation. A storage class that acts as an extension of the Matrix class may have the form of the following example:
i. Storage<Symbol, String, Content>
   in which the rows represented by symbols and the columns represent indicator names. To assist with automation and type evaluation, a minimal set of standard data types can be defined and stored in the matrix. For instance, the following list includes of example data types:
ii. integer type: int (I)
iii. long type: long (L)
iv. float type: double (D) (the JAVA float type won't be used)
v. text strings: String (S)
vi. generic object: Object (0)
vii. array of objects (A<Obj>) (this can also include a recursive definition, e.g., AL (array of longs), AAL (array of array of longs)).

As a result, different content objects may be created to deal with each of the different data types. Within the context of the memory management, a context object is a placeholder object that may wrap around a value of a given type and provide normalized access to the value through a number of standard access methods. The content object defines methods for all the types that it can wrap. An example of a content object is set forth below:
i. ===getter/setter methods===
ii. get/setInt(value:int)
iii. get/setLong(value:long)
iv. get/setDouble(value:double)
v. get/setString(value: String)
vi. get/setObject(value:Object)
vii. get/setArray(value:List)
viii. ===validity methods===
ix. hasValidValue( ) boolean
x. setHasValidValue(value:boolean):boolean
xi. ===old value===
xii. get/set<Type>OldValue(value:<Type>)
xiii. setHasOldValue(value:boolean)
xiv. hasOldValue( ):boolean
xv. ===calculation required===
xvi. subscribe( )
xvii. unsubscribe( )
xviii. hasSubscriptions( ):Boolean
   As can be seen in the foregoing statements, a content object may include access methods for the data type (“getter/setter” methods) and access methods for subscriptions (“calculation require”). Preferably, each content objects in the same column of the storage model is wrapped around the same data type. In some implementations, there may be an attempt to access from the object a data type that is different than the stored data type. In that case, the content object may return a pre-set value in the incorrect data type or a null value.

When the structure of the storage model changes (e.g., a row is added or deleted, a column is added or deleted, or a cell is added or deleted), the meta-data information associated with the storage model changes. This means that as long as one column stays the same, the meta-data associated with the content objects of the cells in the column do not change. Besides having the advantage of allowing simple data types to be stored, it also allows different extensions that will increase its functionality. For example, it can have a flag that specifies whether the object contains a valid value or not.

The content object also may include methods for accessing old values. For example, in some implementations, a change in a content's value requires the content to save the old value until the end of the current iteration. Using the access methods “setHasOldValue(value:boolean)” and “hasOldValue( ):Boolean,” a content object can be labeled as storing an old value. In some implementations, setting the old value of the content object may be automated.

For certain uses and types, it may not make sense for the old value to be stored. Indeed, storing large arrays of old values may be wasteful if not every old value is needed. In such cases, the old values are not stored or only the type of change to the data values is stored.

Preferably, calculations that are not needed should be avoided. Thus, in some implementations, it may not be necessary to go through the subscription counter checking for setting values. Instead, the faster operation may include the observer checking the content object directly. However, in some cases, the content object may not be valid. Accordingly, the content object can include a flag to specify whether or not the content object is supposed to receive data or not, such as the “validity methods” indicated in the content object above.

Observer Model

A module (or sub-module) in the electronic financial trading platform watches both the meta-data and the content of a storage model relevant to the calculations the module may need to perform. The observer model 220 provides the registration tools for a module to register with the relevant storage model. The observer model 220 notifies observer/listener components of the modules when changes to the data and to the meta-data of the storage model 210 occur. The observer model 220 should provide two types of observers for each storage model with which a module (or sub-module) may be registered: one for the meta-data and another for the content of the storage model 210. The observer model 220, together with the storage model 210, simplifies detection of locations in the storage model 210 where changes have occurred (e.g., any time a price or size of a financial product has changed or when rows or columns have been added). If the structure was to change and the observer does not adjust the references appropriately, then the references may no longer point to the same object in the storage model or to any valid object for that matter.

However, in certain implementations, it is preferable that such notifications do not occur (e.g., in cases where all the changes should be viewed as a single event). For instance, consider an example where the storage model has the structure [symbol, price, size] and the user is interested in placing a trade when the value of a trade (defined as price*size) has a certain value (e.g., greater than or equal to $80,000). A calculator that calculates a value field (changing the structure of the storage model to [symbol, price, size, value] where value is calculated when price and size are changing) as value=price*size. Initially, the values in the storage structure are [IBM, $80, 100, $8000]. If there is an update with the new price=$79 and new size=1000, the value should be $79000. However, if the update for size occurs first followed by a separate update of price, the following changes in the storage structure would occur: [IBM, $80, 1000, $80000] (trigger), then [IBM, $79, 1000, $79000]. The first update to the structure would trigger the rule and push the trade at the wrong price. The trade itself does not meet the requirement, because the actual value, when all the trade components are accounted for is only $79000. Price and size are defining the trade only together, not separately, so there should be only a single update for price=$79 and size=1000 with value calculated once to $79000. Having separate updates gives a false view of the trade and a fake trigger.

In some implementations, an iterative observer model can be employed through which a change in the storage model 210 triggers further evaluations down a list of observers until the last observer has been reached and each observer can check the modifications made by the observers that preceded it. In certain cases, this particular case requires a dependency mechanism in place that can deal with the order in which fields are evaluated. An example of such a dependency mechanism is described later in this disclosure.

Automation Model

The automation model 230 is somewhat similar to the observer model 220, in that the automation model 230 listens for changes to values in the storage model 210 based on subscriptions of application modules to the storage model. In general, the automation model 230 deals with ways of bringing data into the storage model 210. That is, the automation model 240 is configured to trigger a set of processes for performing a calculation (a “calculator”) in response to one or more changes in the storage model. The set of processes may include operations performed by the application modules. The application modules or other components of the platform 100 that include calculators may have subscriptions to the storage model. When there is a change to the storage model 210 (e.g., a change in value or change in structure of the storage model), the automation model triggers the calculators that have subscribed to the portion of the storage model 210 that has changed.

For example, a reporting module may include a calculator for calculating PnL and relies on data referenced by a first instance of the storage model 210. The output of the calculator may be stored in a different instance of the storage model 210 relating to PnL. Specifically, the reporting module may have a subscription to cells of the storage model 210 that reference the price of a particular financial product (e.g. IBM). When the price of the referenced in a cell of the storage model 210 changes, the calculator of the reporting module is triggered to calculate the new value. The new value then is updated in the instance of the storage model 210 relating to PnL. The automation model 230 is not limited to observers that contribute data (i.e., writers) but also includes overriding conditions.

Overriding conditions include instances where an external data source provides data to a local calculator (e.g., a calculator on a machine such as a client workstation) of an application. In certain implementations, however, the calculation is too time-consuming to perform using the local calculator alone. For example, a formula for calculating a value for thousands of different financial products may require multiple iterations or recursion levels that cannot be completed in an acceptable amount of time with the existing hardware resources. In this case, the calculation is distributed across the client workstation, on which the local calculator runs, and one or more additional computing devices (e.g., a distributed server). Thus, the automation model 230 instructs the module running on the client workstation to obtain its data for the application from the internal calculator and the other computer devices. That is, the local calculator calculations are overridden by the remote data source.

Another overriding condition that may need to be addressed occurs when evaluating the values of memory objects. As previously discussed, new values may be calculated at anytime an observer is notified of a change. In certain implementations, this results in a waste of computing power, since not all of the object indicators (i.e., information providing insight on the state of an observed object such as, e.g., price, size, trade volume) may be required by observers. If an indicator is not required by a particular observer, the automation model 230 should be configured to effectively switch on or off evaluation of the object field corresponding to the indicator. Thus, a notification mechanism is required. The notification mechanism may be considered to be a part of the observer model 220.

Several additional features of the memory management system 200 will now be discussed. First of all, to maintain the consistency of the storage model 210 (i.e., to ensure that changes in meta-data or content occur in the proper order), both the meta-data notifications and the content change notifications are synchronized such that observers are notified as changes in meta-data changes occur. In some implementations, changes in the meta-data may happen during content change notifications. In such cases, meta-data notifications (regarding changes in the storage model 210 itself) are sent to the observers before the observers are notified of the current content change. The meta-data notifications allow observers to retrieve the new values of the indexes for the fields and symbols the observers are interested in. As a result, each observer maintains the correct values for the indexes and may access the data in the storage model 210 using direct access. Preferably, the storage model 210 offers getter/setter methods that query the value of a content object using the content object's exact location in the matrix.

Preferably, a meta-data observer makes sure that the notifications are not blocking and do not require object wide synchronization. The meta-data observer remaps the indexes of the storage model in case the meta-data changes. For instance, consider an example in which an observer notification method specifies a change to meta-data in which the observer notification method is declared as:
i. layoutChanged(Map<Symbol>symbols, Map<String>indicators)
   Furthermore, assume the meta-data observer is interested in the LAST values for the symbols “IBM” and “MSFT.” The meta-data observer then could implement the observer notification as follows:
ii. msftLastIndex=symbols.get(“MSFT”);
iii. ibmLastIndex=symbols.get(“IBM”);
iv. lastIndex=indicators.get(“LAST”);
   or the observer can use the matrix meta-data access methods to accomplish the same thing. The code that uses those variables cannot lock the storage model to make changes until a previous access change unlocks the object. Since any change to the content or meta-data requires synchronization once this object locks the memory model, it is guaranteed that it has the correct indexes (or −1 indexes for which there can be safeguards in the access methods) to retrieve the information right away. Since the layout is supposed to stay the same for a longer period of time, without changing as fast as the content, the indexes collected at the last layout change can be used safely to retrieve content values in a synchronized way until the next layout change.

An issue that may arise with the removal of fields and symbols is that it may lead to unused space (either at the end or in the middle of the matrix). To avoid the waste of unused space, the space may be compacted. Compacting unused space in a storage model can be done automatically by removing the unused data, compacting the matrix, and notifying observers in the process. In some cases, a delayed cleanup may also be implemented. In a delayed cleanup of unused spaces, there is a separation between logical deletion of values in the unused spaces (with corresponding notifications issued to observers about the logical deletion) and later removal of the unused spaces/compacting of the matrix (with another set of corresponding notifications issued to observers, since compacting will change the indexes in some cases).

The content change notifications are more complex than the meta-data notifications. The content change notifications are supposed to notify any interested observers that the value of certain fields has changed. To minimize delay and overhead, the observers need to be able to quickly discover the fields that have changed and, in some cases, the old content for a cell needs to be preserved for the entire period of the notification (e.g., until all the observers have been notified of the change).

Depending on how the notifications are implemented, there may be several problems that arise. For example, given the potentially very large number of symbol—field combinations (which can, in some implementations, reach thousands by thousands of cells), the use of the content as the observable object may be unfeasible due to excessively large memory requirements.

Additionally, if a collector uses a lookup in a data structure that is a map or a list (or array), the guaranteed bound for this solution is equal to the entire number of content objects (number of lines*number of columns).

One approach that may overcome the foregoing drawbacks is to use a change variable in the content objects and add the following methods to the methods existing in each content object:
set/getChanged (value:boolean)

The addition of the change variable and methods to the content objects allows an observer to probe for the change directly. That is, an observer know has information indicating whether or not content within a cell has changed. To further narrow the search and improve the efficiency of the notification process, two arrays of boolean values, one for the row symbols and one for the column fields, may be added to the storage structure. The boolean values for a row or column will be set if there was a change on the given row or column, and thus provide an observer the ability to identify the area of the storage model in which the content changes have occurred.

Nonetheless, a module would still have to perform two searches of the Boolean arrays to find out all the changes that occurred in both the rows and the columns. To further optimize the check for change in content, two more arrays (one for fields and one for symbols) may be added to the storage structure. As explained above, the previous arrays that were added register whether or not there was a change on the symbol at a specific location. The two new arrays, however, only add a new row symbol (or column field) after a change occurs in that row (or column). In this way, an observer may quickly check the second array to identify the row and/or column in which the change occurred without having to search through an entire array of the same row or column size as the row or column size of the storage structure. It should be noted that for implementations in which there are multiple changes to the same row or same column within a set of operations, subsequent changes to the row or column do not result in additional symbols or fields being added to the second array. Instead, a new entry is added to the second row or column array only if the new entry corresponds to the first change that occurred for the particular symbol or field represented by the row or column, respectively. The structures used in the solution have well known bounds and there are no surprises caused by unbounded data structures that carry changes. Thus, by modifying the content objects to include the change variable and access methods, and by adding the two boolean arrays to each storage model, a module interested in a particular set of fields within the storage model can readily perform fast look-ups, further optimizing the module's real-time performance in the trading platform.

Parallel Notifications Based on a Dependency Graph

In some implementations, multiple observers/listeners will be employed by various modules of the electronic financial trading platform 100. In certain cases, the input of one or more observers depends on the output of one or more other observers. That is, one or more calculators of an application module may not be able to perform their calculations until a previous calculator or application module (which has been notified through an observer component) has updated the content of a corresponding storage model. For example, a module (or sub-module) in the platform 100 that simulates a trade of a financial product under a specified scenario (e.g., market conditions at a particular data in history) may include multiple observer components for calculating the simulation. Each observer component, in turn, may require as an input, the output value calculated by one or more observers from different modules in the platform 100. Moreover, in some implementations, multiple modules of the platform 100 may perform calculations, in which the observer components of each of those modules depend on the output of one or more other observer components. If an observer component performs a calculation without first ensuring that its input data corresponds to the most recent value available, the output of the observer component may contain an incorrect value.

To ensure that the components (e.g., calculators) of the application modules perform their corresponding calculations in the correct sequence and to optimize the execution of operations among the modules, the memory management system 200 includes a listener manager that automatically arranges the observers according to a dependency graph, such that an observer component is notified once all the previous components on which the observer component depends have finished processing their data. A listener manager is a component of the observer model 220. The order of the nodes in the dependency graph should be non-cyclical. That is, the dependency graph should not include any connections in which the nodes of the graph may end up in an infinite loop.

Observer components are notified based on their subscriptions. The subscription can be explicit for an observer component that wants to receive updates. For example, an application developer can pre-set the subscriptions for an observer component of a module in the platform. Alternatively, or in addition, a subscription can be implicit for an observer that advertises the values in which the observer is interested. That is, the subscriptions may be implicitly generated by the observer model of the memory management system.

Serialization of notifications cannot be avoided when a first observer has to be notified only after a separate second observer (on which the first observer depends) finishes processing its data. However, there may be cases in which the output of a single observer is tied to multiple subsequent observers that have dependencies between one another.

A dependency graph may be seen as a special kind of dependency tree that allows parent nodes to share children nodes, i.e., children may have multiple parents. The condition for a child observer to be notified is that all of the child's parent observers must have finished processing their data.

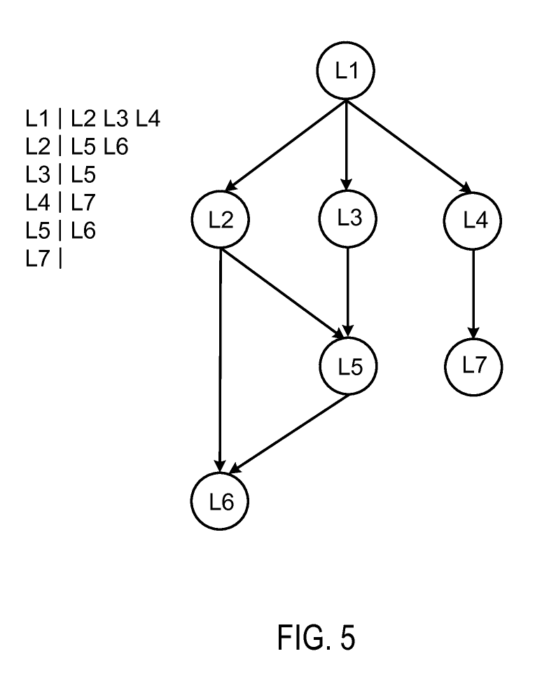

A sample dependency graph is shown in FIG. 5. Each circle corresponds to an observer node such as observer L1, observer L2, observer L3, etc. The arrows point from the dependency to the dependents to exemplify the control flow. In the example shown in FIG. 5, after the notification that parent observer node L1 has completed processing its data, child observer nodes L2, L3 and L4 can be executed in any order.

In some implementations, a thread pool exists in which the child observer nodes are notified and executed in parallel. That is, rather than using a single thread, multiple threads may be utilized to allow the nodes to be executed in parallel as they are cleared in the dependency graph. A condition of multi-threaded environments is that a thread must be available for processing the current node. Thus, in certain implementations, multi-threaded processing further optimizes the real-time performance of modules (and/or sub-modules) of the platform on top of the throughput advantages obtained from implementing the dependency tree.

Child nodes L2 and L3 are parent observer nodes to child observer node L5. Similarly, child node L4 is a parent observer node to child observer node L7. When node L4 finishes processing its data, then child observer node L7 is notified and can execute its process. After being notified by L4, child node L7 executes its process regardless of whether nodes L2 and L3 have finished. However, node L5 must wait until both node L2 and node L3 finish their execution. Likewise, node L6 can only be started when node L5 finishes (which necessarily requires that node L2 has finished executing its process).

The dependency depicted in FIG. 5 can also be described using text as <dependence>|<dependent1> <dependent2> . . . , in which “dependence” refers to the parent node on which “dependent1,” “dependent2,” etc. are dependent. that is subject to three input/output processes that do not collide.

In some implementations, an observer component may employ a reference counter. A reference count corresponds to the number of references an observer makes to memory objects. In the present example, a child observer component will have a reference count that tracks all the parent observers on which it depends for execution. When parent observer component has completed processing the data of a particular memory object, the child observer that requires the value of the memory object as an input will decrement the reference count. If the reference count reaches 0 that means there are no other parent observers remaining that need to execute a particular process before the child observer can execute its own process. By using reference counting for each node in the dependency graph and executing the nodes that have the reference count equal to zero, it is possible to move from a sequential execution to a parallel execution in multi-threaded environments.

Registration Tokens

Typically, in order to keep the data structures and data access consistent, an observer component listens for meta-data updates and learns the layout of content information (e.g., the matrix layout) in a memory storage model. This requires the application module to be familiar with the layout of the storage model. In some implementations, however, this requirement can be avoided by wrapping access to the content objects of a storage model in a registration token that is retrieved from the memory manager. The token is used by the application modules to retrieve and set values in the storage model. Tokens are specific to storage models and depend on the particular subscription. The tokens are managed internally to the observer model and receive meta-data updates instead of the application module. The token automatically adjusts to the new meta-data by searching for new locations indicated by the meta-data when the layout changes or by invalidating itself if the token doesn't represent a valid entry in the memory manager. For example, if cells of the storage model are deleted, the token may be marked as invalid. Thus, application modules may be added to the electronic financial trading platform without requiring that the modules learn the structure of the storage model.

There are different types of tokens based on the types of subscriptions available to an observer component:
Content subscription (ContentRegistrationToken)—content subscription tokens are specific for individual memory locations/cells of a matrix. In a matrix context, this token may contain field information (row class and column class objects) and the current mappings. This token may be used to retrieve or set the content of a specific memory location in the memory storage model.
Row subscription (RowRegistrationToken)—row subscription tokens are used to subscribe to an entire row. This means that whenever one or more values in a row have changed the token can be used to sequentially go through (iterate) the changed values. The token itself can generate an iterator object that will iterate over the changed values. The same token may be used to find the location of a value based on the row number and the column given by the current iterator (that goes through all the columns that have changed values).
Column subscription (ColumnRegistrationToken)—column subscription tokens subscribe to an entire column. This means that whenever values in a column have changed the token can be used to go through the changed values. The token itself can generate an iterator object that will iterate over the changed values. The same token may be used to find the location of a valued based on the column number and the row given by the current iterator (that goes through all the rows that have changed values).
Full subscription (FullRegistrationToken)—the full subscription token can be used to register events for the entire memory manager. The full subscription token provides both row and column iterators to retrieve all the changed locations.

Expanding the Memory Manager to a Relational Memory Management System

Using a memory manager system that employs symbols for rows and indicators for columns may make it difficult to store different types of information that require additional references for locating the data. That is, for different types of data (e.g., market data, trade data, news data, etc.), it may be necessary to use different instances of the memory management system. One option is to force the different data into a single storage model that is expanded in more than 2 or 3 dimensions. However, there are certain cases where expanding to additional dimensions may not be feasible. Furthermore, the memory waste may grow beyond what the memory manager can compensate.

In some implementations, it is easier to instead establish multiple different instances of the storage model, each storage model instance having its own specific purpose. For example, one storage model instance may contain information about symbols (e.g., primary exchange, company, listings, tick size, or standard codes), another storage model instance may contain price information about the symbols, and yet another storage model instance may contain information about a user's trading position. Locating the data within these different storage models needs to take into account the meta-data of each storage model. For example, each storage model may have different bounds for the matrix/arrays. One template may have, e.g., 10 rows (e.g., symbols) with 20 columns (e.g., indicators), whereas another storage model may have a single row with 10 columns.

The multiple storage model instances can be grouped together using a relational memory management system. The term “relational” is understood in this context to imply that the different memory managers serve as specialized tables and the memory management system becomes a data base management system (DBMS).

In the relational memory management system, it is possible that information located in a first storage model instance may also be located in a second different storage model instance either as a template parameter or as a regular column. This means that relations between the storage model instances can be defined so queries from applications external to the trading platform reach beyond the borders of one storage model. Moreover, calculations can be based on unions of information from more than one storage model instance. The storage models can be linked together using common fields or parameters that are guaranteed to exist for those storage models and to have the same meaning In general, the row template parameter can be seen as the primary key and the column fields (while they too can be seen as primary keys as a template parameter) can be seen as potential foreign keys.

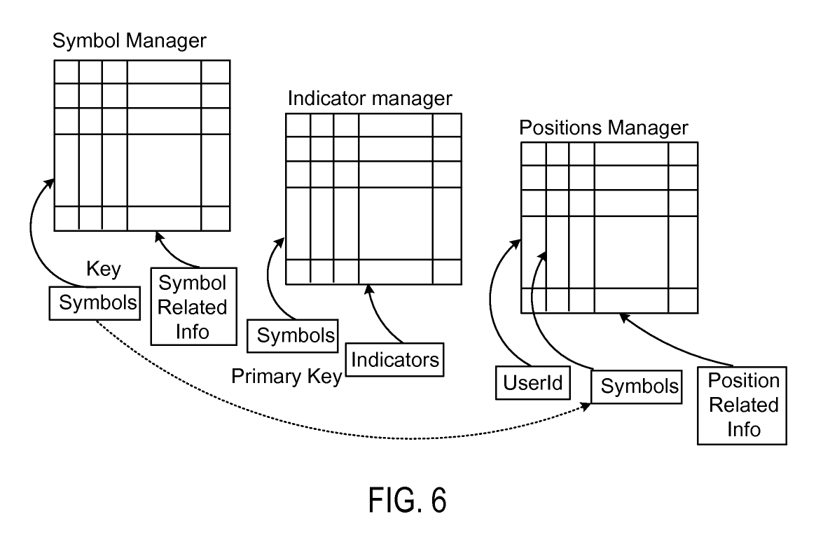

FIG. 6 is a diagram of an example of a relational memory management system that includes several different storage model instances. In the Symbol Manager shown in FIG. 6, the template parameters are “Symbols” (for rows) and symbol description fields “Symbol Related Info”) for the columns. In the Indicator Manager, the template parameters are “Symbols” (for rows) and “Indicators” for columns. In the Positions Manager, the template parameters are “UserId” (for rows) and trading/risk position description fields for columns. A symbol field of type “Symbols” is also guaranteed to exist in the Positions Manager. In the example, “Symbols” is a primary key in both the Symbol Manager and the Indicator Manager, and a foreign key in the Positions Manager. By setting the “Symbols” as a foreign key in the Positions Manager, information can be retrieved from the different storage models using only one query and the available relations between the storage models.

For a relational memory management system, a registration token is expanded to have a reference to the storage model instance for which the token was issued. The iteration object generated by the token can be used to retrieve data from other storage model instances in addition to the storage model instance for which the token was issued.

### Data Compression and Caching

In addition to the advantages in processing speed obtained through the use of the memory management system described above, the electronic financial trading system also is able to provide real-time data analysis through the use of enhanced data compression. The enhanced data compression techniques described below may be useful when transferring data to and receiving data (e.g., data in the form of reports) from a client workstation or a data vendor.

Generally, when a distribution server of the electronic financial trading platform receives data (e.g., market data, news, trade data, etc.) from a vendor, the data may be converted to ASCII text format or is in ASCII text format already. One reason for this is ASCII format is a universal character-encoding scheme that is recognized by most, if not all, computing systems. Thus, instead of configuring the electronic financial trading platform and its modules to recognize a variety of different character-encoding schemes that may be associated with data from the different vendors, which would increase processing overhead, the system receives and sends data in ASCII format. However, one potential problem with transferring data in ASCII format is that each number displayed in a value (e.g., “2,” “0,” and “0,” in the value 200) must also be represented in ASCII format, requiring far more memory than if an encoding-scheme listing just the value itself was used. For example, the value 200 would be represented by 3 bytes of data (1 byte for each character). Furthermore, there are a relatively large number of steps a processor must take to convert an ASCII character text value to an internal binary value the processor can use in an actual calculation. For example, for the value 200 in a textual representation, a system would have to reach each character (“2,” “0,” and “0), find the internal binary value from the character code, and perform addition operations until there are no more characters to convert. In larger numbers, multiplication operations may also be required as part of the conversion. Thus, in messages containing many numbers, converting a data message can require a substantial amount of time. Additionally, the ASCII format is limited in terms of the characters that can be used. That is, ASCII may not be expanded to cover certain characters present in other languages (e.g., Mandarin) without special provisions that increase the size of a message.

In order to reduce the amount of data transmitted, and expand the number of characters capable of being represented in a transmission, a component of the electronic financial trading platform 100 (e.g., the accounting database module 102, the reporting module 106, or the core trading module 108), the client workstation, a data vendor device, or other device external to the platform 100, may pack transmitted data or unpack received data according to the technique described herein. This model of data compression, along with other techniques, may be used to facilitate the real-time responsiveness of the financial systems described in this document. In some cases, efficient data transmission may be needed for real-time operation, and financial systems may use other techniques in addition to or in place of this model to ensure such efficiency. In some implementations, this data compression technique may represent an increase in efficiency over uncompressed data on the order of the compression ratio of the compressed data. This technique may be used on data that is to be, for example, transmitted across a data network from one computing device to another. It should be noted that the model data compression and data storage described here may be used by any appropriate computer system, in addition to the electronic financial trading platform 100.

The technique for data compression and/or caching entails representing the fields of a message in a portable binary format that allows data encoding using a representation that is much closer to machine representation to eliminate overhead of using character strings and reduce representation size. Moreover, the present technique moves away from fixed size representation of different data types having different ranges, and instead utilizes a dynamic sizing approach in which similar data types (e.g., same type, different range) are grouped under one serialized data type that can hold the required ranges and uses the smallest representation possible for a given value. That is, the different data types will be configured as a single type for the purpose of transmitting and receiving data and the value will be packed using just enough bytes to hold that specific value. The present technique overcomes the problem of determining how many bytes to read for a particular message by including a header to each message that contains the message count followed by fields that specify length information for the particular data type.

The message compression mechanism described herein works together with the caching mechanism to provide smaller messages for cache synchronization and message delivery. There are two points during data transmission where the messages are reduced in size: when selecting the fields to transmit (the differential) and when the message is constructed. In general, when subscribing to a specific data set, the receiving device (e.g., client) will receive synchronization messages that will allow it to have an exact copy of the transmitting device's (e.g., server) cached data. This is where the first step of reducing message size occurs. Once the transmitting device has sent the synchronization messages, the transmitting device assumes that the receiving device reflects the transmitting device's own cache and the transmitting device will only send messages that contain only the fields that have changed their values in the cache instead of sending all the fields required by a specific structure. An event message will still be sent to notify the receiving device of the event but not all the fields will be sent if not all of the fields have changed.

The second point occurs when the messages are being constructed. There are a number of factors that come into play when constructing the message. The first factor is byte representation, which takes into consideration the size of the message in bits, the order of the bits within a byte and the ability to create a set of bit masks. For the purposes of the compression technique described herein, an 8 bit-byte (i.e., an octet) will be the primary field size, enforcing the limits used in the C (ISO 89, 90, 99) standard. In some implementations, if the byte is larger than 8 bits, then portion used to store information can be restricted to the first 8 bits of the byte. It is assumed that the bits are laid out in little endian order within one byte (i.e., where bit 0 is the least significant, bit 7 the most significant), as this is the most prevalent organization (with the exception of very exotic hardware). Preferably, the platform on which the caching and compression are implemented supports 256 different masks than can be applied to the bits, independent of the value the bits represent internally. Values may be constructed from the mask as if they were a regular binary representation of the number, with bit 0 as the least significant bit.

Thus, one byte can provide 256 (from 0 to 255) different values. Depending on the internal representation some masks can represent the same value (e.g. “one’ representation has both negative and positive 0). In these rare cases the value must be constructed using the actual mask rather than using the internal representation.

Another factor is endianess of the bytes. Byte endianess corresponds to the order of the bytes within a multibyte structure. For the present examples, big endianess will be the order used since numbers represented as big endian can be easily constructed on the fly, thus allowing a parser to reconstruct data structures as the data becomes available (i.e., without the need to read the whole message first).

Another factor is the character set used for the compressed messages. As explained above, a large number of communication protocols are still heavily dependent on the ASCII character set due to the universal nature of ASCII, yet this requires special provisions to convert to characters not supported by ASCII that increases the size of a message. The present technique seeks to easily transfer characters from substantially any character set without conflicts.

Another factor is the data type. The present technique seeks to carry multiple different data types including fundamental data types (e.g., boolean, signed and unsigned integers, floating point values, and character strings), composite data types (e.g., data types created using fundamental data types chained together), and custom data types

Another factor when constructing the message is the type ranges. That is, for each data type, there is a specific range that can be represented (e.g., min/max values for numbers, lengths for sequences, custom ranges for other types).

Another factor is representation precision and availability. The present technique seeks to represent a large number of fields exactly as a rational number rather than as floating point. Additionally, the technique provides the capability to represent the fact that a value has changed, but that there is no replacement value for the new value (e.g., NULL value).

As explained above, there can be a significant overhead when serializing and de-serializing data types to and from string representation. In some implementations, compression techniques with smaller latency restrictions (e.g., bzip2 or gzip style compression) can be used but they require buffering messages together to create longer messages. This is not feasible for a real-time data delivery system, where messages cannot be cached until a certain arbitrary threshold is met and where most of the messages are too small to provide enough data for arithmetic compression.

In the present compression technique, fields are represented in a portable binary format that allows data encoding using a representation that is much closer to the machine representation. The format is portable given that it is not dependent on a specific platform's internal representation, and can be implemented in an almost identical fashion on all the most common architectures. The portable binary format eliminates the overhead of using character strings and reduces the representation size. Thus, using the portable binary encoding saves space compared to a message employing solely string representation of characters. For example, in binary encoding, 1 byte can be used to represent the value 127 whereas for a string representation, the value 127 requires 3 bytes given that each character in the number is represented using a single byte. For wider string character sets, the number of required bytes may even double. Thus, for a large number of values the binary format can potentially result in substantially reduced message memory footprint.

The present approach further minimizes the memory required per message by employing dynamic message sizing. Dynamic message sizing entails shrinking the message further based on the choice of data type included in the message, while preserving the original information (lossless). The choice of data type for representing numeric values depends on the values that the type must hold. In other words, the dynamic message sizing moves away from a fixed size representation of different data types having different ranges, to a representation in which similar data types (e.g., data of the same type but different range) are grouped under the same data type that can hold each range and use the smallest representation possible for a given value.

As an example, consider the following JAVA data types: byte, short, int, and long. Each data type represents signed values falling within a different range, and each data type uses a different number of fixed bytes for representation (e.g., 1 byte for byte, 2 bytes for short, 4 bytes for int, and 8 bytes for long). For the purpose of transmitting data using the present compression technique, each of these data types is understood as corresponding to a single nonspecific data type, and the value contained within each message will be packed using just enough bytes to hold that specific value rather than using the maximum 8 bytes required for a long integer (unless 8 bytes is required to hold the value).

One problem that surfaces with using dynamically sized types is that, if all the bits are used to hold the actual content value, it is difficult to determine how many bytes need to be read to reconstruct the value. To address the problem of determining how many bytes are needed, a control block field is added to each message, in which the control block specifies the length (e.g., how many bytes) allocated for each data type in the message. To minimize waste, each unit of control specified by the control block is 4 bits long. That is, each byte of the control block is split into control nibbles (1 nibble=4 bits, 1 octet=2 nibbles). Since full bytes are used for the control block, the worst case scenario is that there is an odd number of content fields specified in the message, such that the last nibble in the header will not be used. However, even in cases where there is an extra nibble in the control block, the 4 bits may, in certain implementations, contain information other than just the length of the representation for the purpose of micro-optimization. For example, the additional nibble may be used to store binary data representative of commands to be performed on the values transmitted in the data message.

The value represented in the first and second nibble can be created from the byte as follows:

nibble1=2³·b₇+2²·b₆+2¹·b₅·b₄ i.

nibble2=2³·b₃+2²·b₂+2¹·b₁+2⁰·b₀ ii.

where bₙ corresponds to the bit position in the byte, with b₀ corresponding to the least significant bit and b₇ corresponding to the most significant bit. By convention, a nibble with a value of 0 (zero) denotes an undefined value (NULL). The remaining 15 values in the nibble are used to specify the properties of the fields.

The general form of messages packed according to the foregoing dynamic sizing can be represented as follows:

### [MessageCount] {[FieldCount] ControlNibbleBlock [[ [Type] Fieldld] FieldValue] . . . }

The MessageCount field is an unsigned long value specifying the number of messages included in a particular frame for data transmission. Alternatively, the message count may be understood as specifying the number of sub-messages contained within a message packet. The width of the message count can be predefined. As an example, the width may be 1 byte, 2 bytes or 3 bytes. Other widths are possible as well.

Each message may be prefaced by the FieldCount field, which specifies the number of content fields within each message in a frame. If the field count is known beforehand by the entities participating in the communication (i.e., the receiving and transmitting entities), the FieldCount may be left out for a frame having a fixed form. Fixed form frames include messages that have a fixed number of required parameters and no optional parameters. Furthermore, the order in which the parameters are placed inside the message/frame is always the same in fixed form frames.

The ControlNibbleBlock field is required for every message and specifies the length representation for each element of the tuple in the message. The tuple is represented by Type+FieldID+FieldValue. The “Type” field is a long value representing a field type for the field value. The “FieldID” is a long value representing a field identification/field number for the field value. The meaning assigned to field type and fieldID typically are established by according to a protocol accepted by the receiving and transmitting parties before the message is transmitted. For example, the field type may specify that the field value is a string (e.g., “IBM”). Depending on the protocol implemented by the transmitting and receiving parties, a number is assigned to the “Type” field that is understood by the parties to represent string. Similarly, the FieldID may specify an identification of the value as corresponding to a stock symbol. In this case, the value corresponding to that identification would be entered into the fieldID field. The “FieldValue” is the actual compressed value for a given field, i.e., the content field. In the example above, the actual value is “IBM.”

Any of the Type or FieldID fields may be left out (starting from left to right) depending on what is known about the message form beforehand by the parties participating in the communication. Four general types of message forms can be used with the present compression technique:
i. The type, fieldID and values are unknown within the message: in this case all three field properties must be present in the message.
ii. The fields are part of a well-defined set. In this case both parties to the communication know the type of the fields and only the fieldID and the value are required.
iii. The fields are part of a fixed form message. In this case the type of the fields and the order of the fields is known in advance (which means that the fieldID is known) and all the fields are mandatory. In this case, the fieldID is not required, as the value is enough.
iv. In formats where the number of fields is specified, not all the fields associated with an event have to appear in the message for that event. For instance, assume two messages are pushed in which size field remains the same for the second message. The second message then can be pushed without the size field because that field has not changed. That means that the field will not be counted in field count and its nibble, type, id and value will not be part of the message.

For undefined messages (or for fields like Boolean fields) the FieldValue field may be missing as well.

The control block can be used to define fields for custom data types as well as the following common data types.

Boolean: A boolean value does not require a special field to represent the value as it is completely defined in the control nibble. Table 1 shows an example of the control nibble values and corresponding Boolean value.

TABLE 1

| Control Nibble | Value |
|---|---|
| 0 | Undefined |
| 1 | TRUE |
| 2 | FALSE |

Long: The long type is a signed integer value that uses the control nibble to specify a length and status. The values are used incrementally, in that ranges do not overlap, i.e., a number that can be represented using n bytes may not be represented using fewer than n or more than n bytes. For example, a number represented using 2 bytes starts with 128; if the number is smaller than 128 then the number only needs 1 byte to be represented. The values are symmetrical with regards to the sign. The first byte will contain the sign as its most significant bit. Data will be represented on the remaining 7 bits of the byte. Each extra byte required for the representation adds 8 bits for the data representation. The value ranges for the representation of the long type are shown in Table 2. The numbers can be represented both as positive and negative values. Due to the incremental nature of the representation the maximum 8 byte value will be larger than any 8 byte signed integer type.

TABLE 2

| Control Nibble | Min | Max |
|---|---|---|
| 0 or >8 | Undefined == 0 | Invalid >8 |
| 1 | 0 | 127 |
| 2 | 128 | 32895 |
| 3 | 32896 | 8421503 |
| 4 | 8521504 | 2155905151 |
| 5 | 2155905152 | 551911719039 |
| 6 | 551911719040 | 141289400074367 |
| 7 | 141289400074368 | 36170086419038335 |
| 8 | 36170086419038336 | 9259542123273814143 |

Base 10 Rational Floating Point: Base 10 Rational Floating point numbers are represented using a base 10 rational type, where the numerator is an integer value and the denominator is a power of 10 represented by an exponent. The structure that is implemented for Base 10 uses the most significant bit of the most significant byte to represent the sign. The next 4 bits of the most significant byte represent the value of the exponent and gives a range for the decimals from 0 to 15. The remaining 3 bits form the integer part. Every other byte added to the representation will add 8 more bits that go toward the representation of the integer part. As with the Long type, the representation is incremental. Representation ranges for the integer part are presented in Table 3. The decimal point can be moved through the number based on the value of the exponent, from right to left.

TABLE 3

| Control Nibble | Min | Max |
|---|---|---|
| 0 or >8 | Undefined == 0 | Invalid >8 |
| 1 | 0 | 7 |
| 2 | 8 | 2055 |
| 3 | 2056 | 526343 |
| 4 | 526344 | 134744071 |
| 5 | 134744072 | 34494482439 |
| 6 | 34494482440 | 8830587504647 |
| 7 | 8830587504648 | 2260630401189895 |
| 8 | 2260630401189896 | 578721382704613383 |

String: The String value represents either a binary array of bytes or an array of bytes that represent an encoded string for a given character set. There is no character set information in the latter case as that should be established beforehand and not as part of every string.

The length of the array is limited to 43,118,110,314 bytes. The String has 3 parts for the representation: the control nibble (like in the other cases), the length prefix and the actual content. The length prefix is represented by a number of bytes (between 0 and 4) that precedes the String's bytes and specifies how many bytes are in the String. The control nibble specifies either the length of the size bytes or the length of the string itself, if the string is very small. For short strings (under 10 bytes) there is no need for a length prefix as the control nibble can provide the value and this optimizes representation of small strings. If the value of the control nibble is 0 (undefined/NULL) then both the length prefix and the byte count is 0 (no bytes should be read for that field).

TABLE 4

Length

| Control Nibble | Byte Count | Min | Max |
|---|---|---|---|
| 0 | 0 | Undefined | Undefined |
| 1 | 1 | 11 | 266 |
| 2 | 2 | 267 | 65802 |
| 3 | 3 | 65803 | 16843018 |
| 4 | 4 | 16843019 | 4311810314 |
| 5 | 0 | 0 (bytes) | 0 (bytes) |
| 6 | 0 | 1 (bytes) | 1 (bytes) |
| 7 | 0 | 2 (bytes) | 2 (bytes) |
| 8 | 0 | 3 (bytes) | 3 (bytes) |
| 9 | 0 | 4 (bytes) | 4 (bytes) |
| 10 | 0 | 5 (bytes) | 5 (bytes) |
| 11 | 0 | 6 (bytes) | 6 (bytes) |
| 12 | 0 | 7 (bytes) | 7 (bytes) |
| 13 | 0 | 8 (bytes) | 8 (bytes) |
| 14 | 0 | 9 (bytes) | 9 (bytes) |
| 15 | 0 | 10 (bytes) | 10 (bytes) |

The String length specifies the length of the String in bytes and not in characters. For example, ‘Hello, world’ will have a length of 12 bytes when represented using ASCII-7 but a length of 24 bytes when represented using the 2-byte universal character set (UCS-2), even though the character length is 12 for both of them.

Unsigned Long: The unsigned long data type is a utility type. It is an uncompressed unsigned integer represented on anywhere from 1 to 7 bytes in big endian notation. Its value is calculated in a similar fashion to a Long type except that there is no sign bit and the values are not considered incrementally (e.g. 1 byte represents 0255, 2 bytes represent 0 65535).

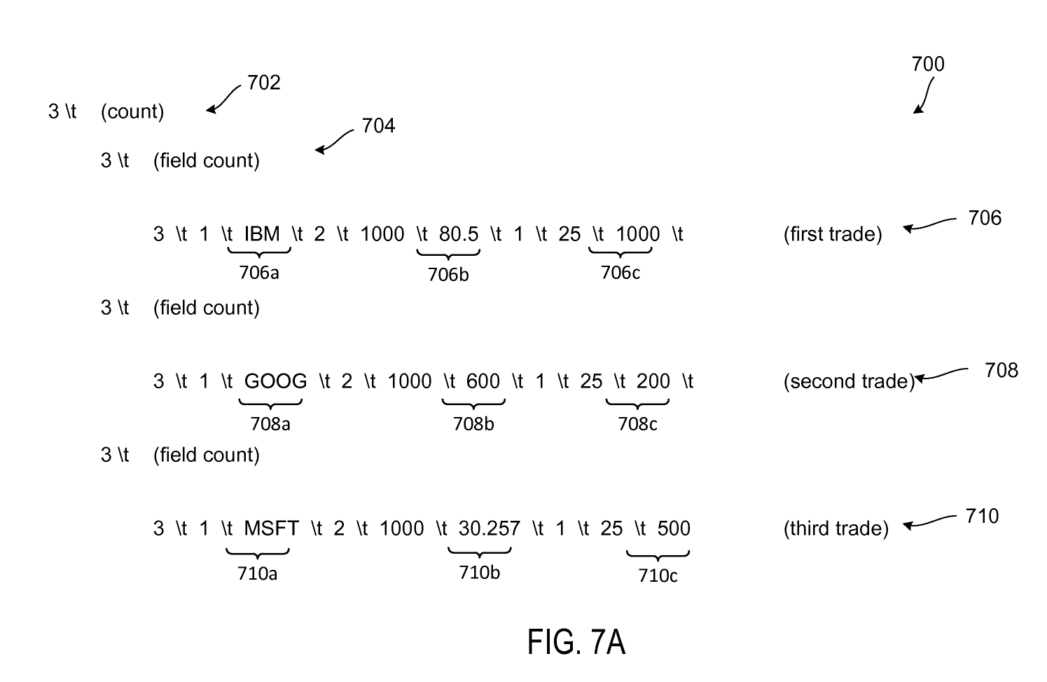

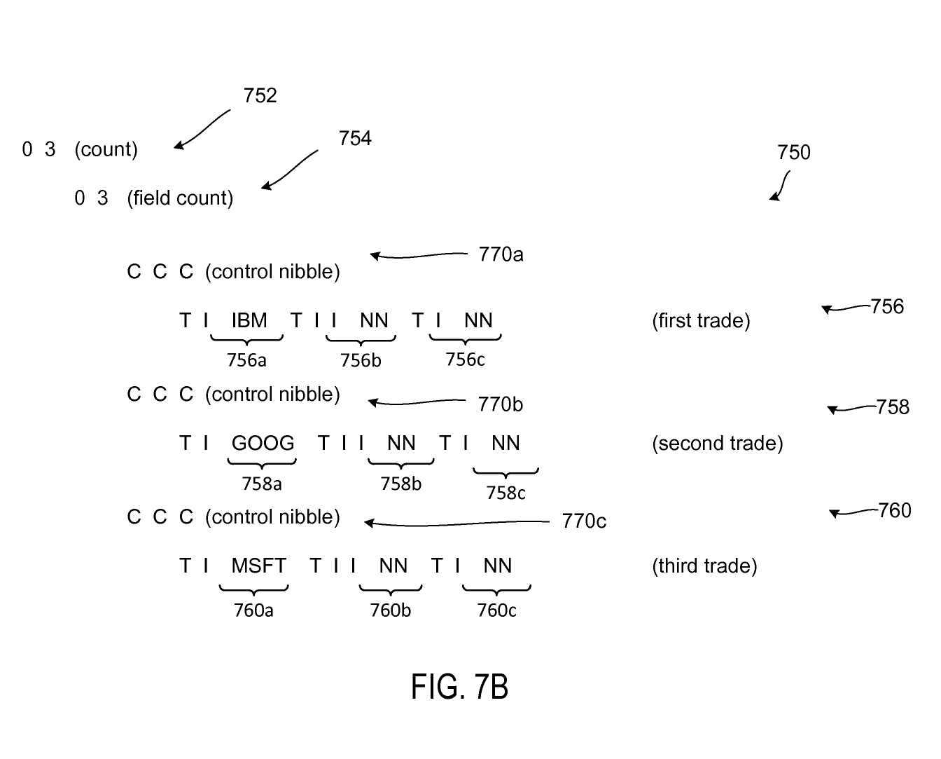

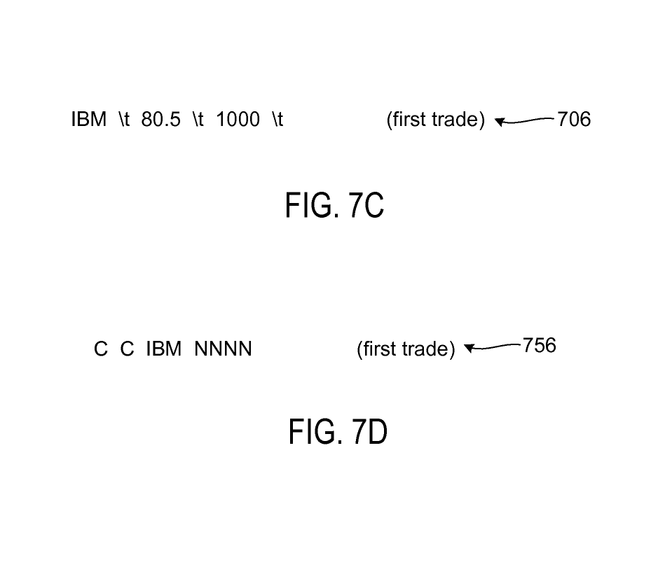

FIG. 7A is a diagram showing the general form of three separate messages packed using string format. FIG. 7B is a diagram showing the general form of messages packed according to the dynamic sizing technique of the present disclosure. The packed messages are examples of trading information being transmitted by a module of an electronic financial trading platform. Specifically, in the examples shown in FIGS. 7A and 7B, the data being transmitted includes information regarding three separate trades: 1000 shares of IBM stock sold at $80.50 per share; 200 shares of GOOG stock sold at $600.00 per share; and 500 shares of MSFT stock sold at $30.257 per share.

As shown in FIG. 7A, the three messages are serialized into separate fields of character strings and concatenated together to form an overall message 700 being transmitted by the module of the electronic financial trading platform. The overall message includes a “count” field 702, a “field count” field 704, a first message portion 706, a second message portion 708, and a third message portion 710. Each field is separated by a TAB character (“\t”) as a delimiter. The “count” field 702 specifies the total number of messages contained within the overall message 700. The “field count” field 704 specifies the number of value fields contained within each message (i.e., the portion of the message that includes the trade information). Each value field within the message portions is prefaced by a field specifying the data type and the field ID of the following value. In the present example, the data type for string is “3,” the data type for rational is “2,” and the data type for an integer is “1.” Similarly, the fieldID indicates the category of the value included in the message. In this example, the fieldID for the first field value is “1” and signifies that the following value is a symbol. Thus, because the symbol value field 706a of first message portion 706 is contains a set of string characters, the field 706a is prefaced by a field containing the value “3” for the data type and a field containing the value “1” for the FieldID. Similarly, since the share price value field 706b contains a rational data type, the field 706b is prefaced by the value “2” for the data type and the value “1000” for the FieldID. Since the size value field 706c is an integer value, the field 706c is prefaced by the value “1” for an integer data type and the value “25” (representative of price) for the Field ID. Second and third message portions 708 and 710 are arranged in a similar manner as first message portion 706. The total number of octets/bytes represented by the overall message 700, include the tab character delimiters is 98.

In contrast, the dynamically sized message 750 shown in FIG. 7B imparts the same information as message 700 but utilizes 58 octets, a 41% reduction in the amount of data required. Message 750 includes a “count” field 752, a “field count” field 754, a first message portion 756, a second message portion 758, and a third message portion 760. The count field 752 specifies the total number of messages contained with the dynamically sized message 750 and the field count field 754 specifies the number of value fields within each message. In contrast to the “count” and “field count” fields 702, 704 of message 700, each of “count” 752 and “field count” 754 holds 2 bytes of information. Each message portion of dynamically sized message 750 is prefaced by a control block (770a, 770b, or 770c) containing control nibbles that specify the information for that particular message portion.

For example, first message portion 756 represents the first trade of 100 shares of IBM stock at $80.50 per share and contains a control block 770a. Control block 770a contains 3 bytes, where each character “C” represents a byte used in the control block. Each value field (e.g., the stock symbol fields 756a, 758a, 760a, the share price fields 756b, 758b, 760b and the size fields 756c, 758c, 760c) within a message portion is preceded by a byte “T” that specifies the data type for the field and a field ID (“I” in FIG. 7B). The characters “N” represent the corresponding bytes for the encoded values of the share price and size of each trade.

When certain fields are known beforehand, such as the type and order of the operands, the messages can be further compressed. However, even after such compression, the dynamically sized message still has a further benefit over the message containing concatenated string characters. For example, FIG. 7C depicts the form the first message portion 706 of FIG. 7A, when the data type and order of the operands is known. As shown in that example, only the string characters and tab delimiters remain. The fields specifying the data type and FieldID are now removed, and the message length is reduced to 14 octets. In contrast, FIG. 7D depicts the form of the first message portion 756 of FIG. 7B after removing the fields for data type and FieldID. As shown in that message, the control bits remain and the message length is reduced to 9 octets, which is a further reduction in the number of bytes necessary for the message compared to the first message portion of FIG. 7C.

### Electronic Financial Trading Platform Reports

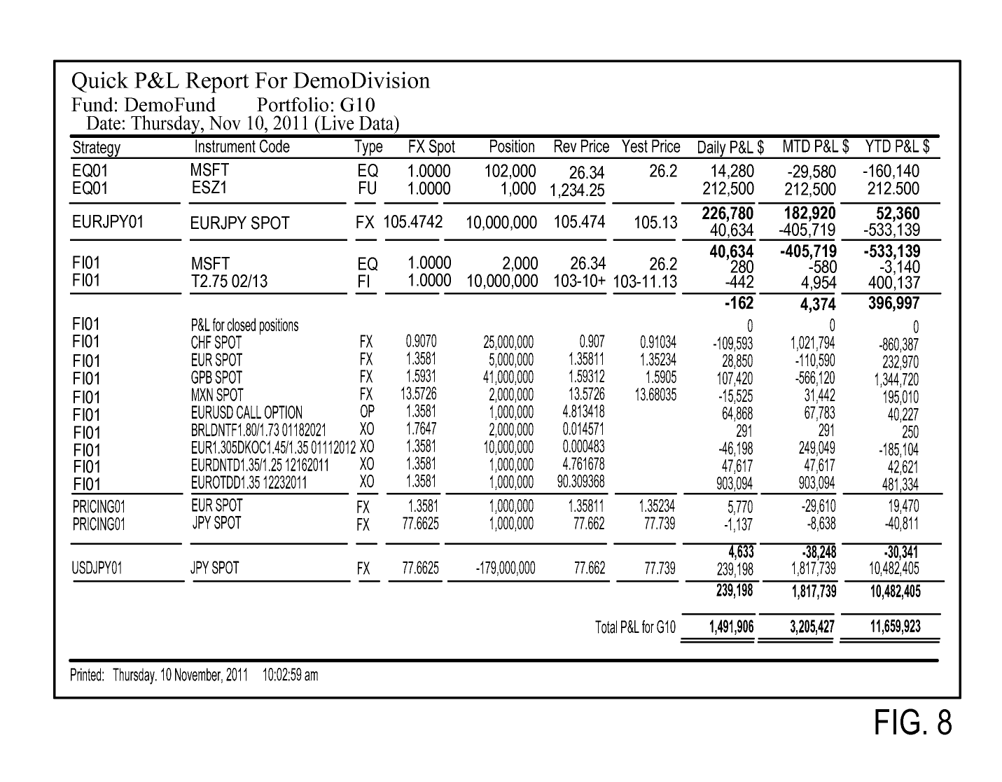

FIGS. 8-19 show example reports that can be generated and updated in real-time using the electronic financial trading platform 100. Among other functions, the trading platform 100 can provide real-time reports relating to position keeping, profit-loss (P/L), performance monitoring and risk management in a multi-currency, multi-asset class environment. All position, performance and risk data is stored on a historical basis and is available for review and analysis purposes. Table 5 provides an overview of the main functionality provided by the reporting system:

TABLE 5

| | |
|---|---|
| Multi-Fund | Supports multiple funds and multiple accounts within a |
| | fund. |
| Multi-Level Hierarchical | Entity/Division/Fund/Portfolio/Strategy/Financial |
| Structure | Instrument hierarchical structure |
| Multi-User Role Based | User access, permissions, and roles can be granularly |
| Access Control (RBAC) | controlled both from a system perspective as well as a |
| | data perspective. |
| Multiple Product Type | Supports Foreign Exchange, Cash Fixed Income, |
| | Equities, Commodities and Interest Rate Swaps |
| | including options and futures on all of the above. |
| Intraday Portfolio Valuation | Profitability and risk can be viewed at any hierarchical |
| | level from an individual financial instrument up to an |
| | entire business entity, as well as across diverse |
| | financial instruments and portfolios and can be |
| | separately monitored by traders, supervisors, or peers |
| | (e.g., partner, manager, investor). |
| Intraday Performance | Net Asset Values (NAVs) are estimated and stored for |
| Estimates | track record analysis on a daily basis. The system |
| | allows a user with appropriate permission to override |
| | the computed NAV with an official NAV that may be |
| | provided by an administrator. Investment performance |
| | history can be viewed on a theoretical or actual basis. |
| Intraday Portfolio | Several reports are available to assist in the |
| Management Reports | management of the portfolio including trade blotters, |
| | position reports, intraday and historical profitability, |
| | profit attribution analysis, volume reports by |
| | counterparty, financing reports and leverage reports. |
| Risk Reporting | Risk Statistics such as U.S. dollar equivalents, duration, |
| | convexity, DV01 (dollar duration) and option greeks |
| | (i.e., quantities representing the sensitivities of the price |
| | of derivatives such as options to a change in underlying |
| | parameters on which the value of an instrument or |
| | portfolio of financial instruments is dependent) are |
| | calculated and displayed for all levels of the |
| | hierarchical structure. Value at risk (VaR) and Stress |
| | Test reports are available in a standard format, again |
| | across all levels of a hierarchy |
| Investor Relations | Performance estimates can be viewed at the investor |
| | level enabling risk, position and performance |
| | transparency reports by investor. Position, performance |
| | and risk are stored historically to provide attribution |
| | analysis for investor transparency and marketing |
| | purposes. |

The reporting screens are provided in a consistent format to speed the process of familiarity with the system. Positions and returns can be viewed at different levels of the hierarchy (e.g., reports can be viewed across an entity, a division, a fund, a financial portfolio, an investment strategy, and individual financial instruments) and reports can be customized to view as much or as little information as required. Reports may be delivered to users via e-mail or similar “push” mechanism, as well as being delivered to and available on a secure and/or customizable/personalizable website. In some implementations, the platform 100 is configured to host the website.

The types of reports the platform 100 is able to generate include, for example, profit-loss (P/L) and trading/risk positions by fund, portfolio, strategy and trader including daily, monthly and year-to-date returns. Trade blotters, financing reports, volume reports and monthly performance breakdowns are provided and can be analyzed in a number of ways including by asset type, market sector and currency. All reports can be viewed showing current intraday figures as well as historically. An example intraday trading position and PL report produced by platform 100 is shown in FIG. 8. The intraday trading position and PL reports may display daily, month to date, and year to date information on trading positions, profits and losses.

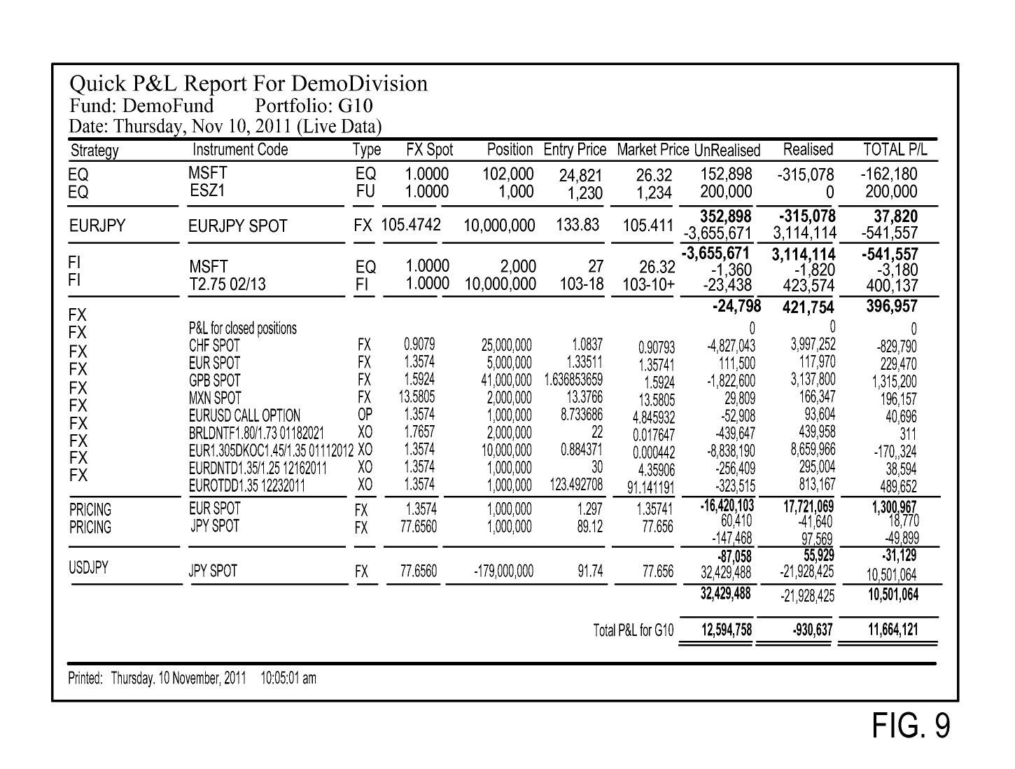

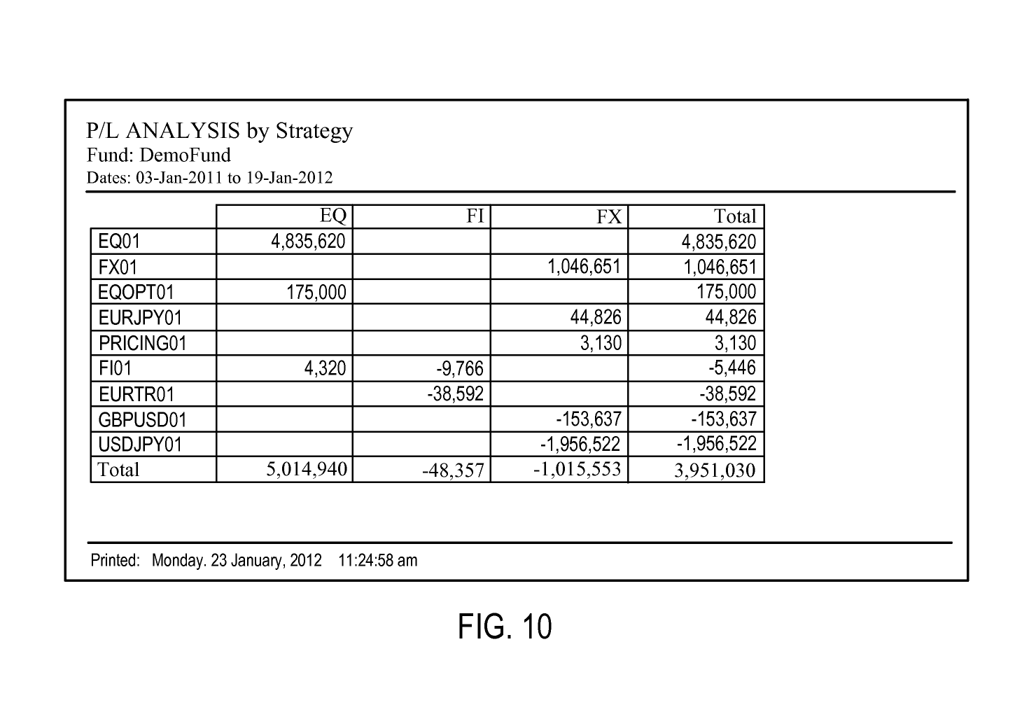

As well as viewing profitability on a daily, month-to-date and year-to-date basis, the platform 100 may also generate reports showing profitability in terms of realized and unrealized P/L calculated on a first-in first-out (FIFO) basis. For instance, FIG. 9 is an example intraday position and PL (realized versus unrealized) report produced by platform 100. The position and PL report may use the same format as the intraday position and PL reports shown in FIG. 8.

As P/L is stored historically, the platform 100 also is capable of analyzing P/L attribution over time and producing reports on the same. For example, an example of a report depicting periodic P/L attribution by analysis produced by platform 100 is shown in FIG. 10. The report may include P/L for every day, week, month, quarter, or year, as desired.

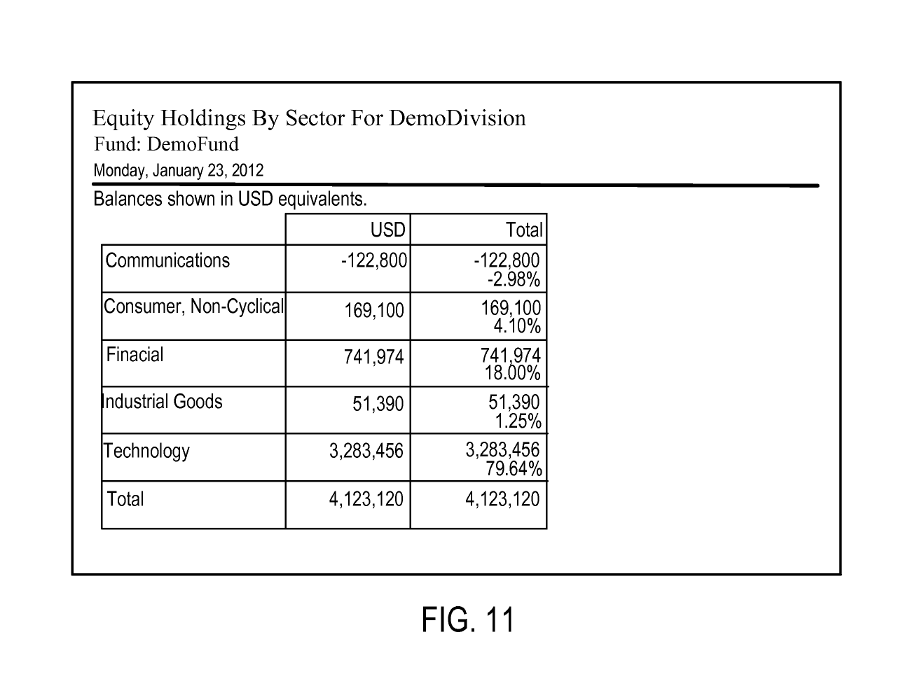

In some implementations, the platform 100 may be used to analyze positions and P/L by strategy, asset class, market sector and currency. For instance, FIG. 11 is a report produced by the electronic platform 100 that depicts an example of equity holding by business sector. The value of holdings may be shown for one or more strategy, asset, class, market sector, or currency, including a total of all holdings.

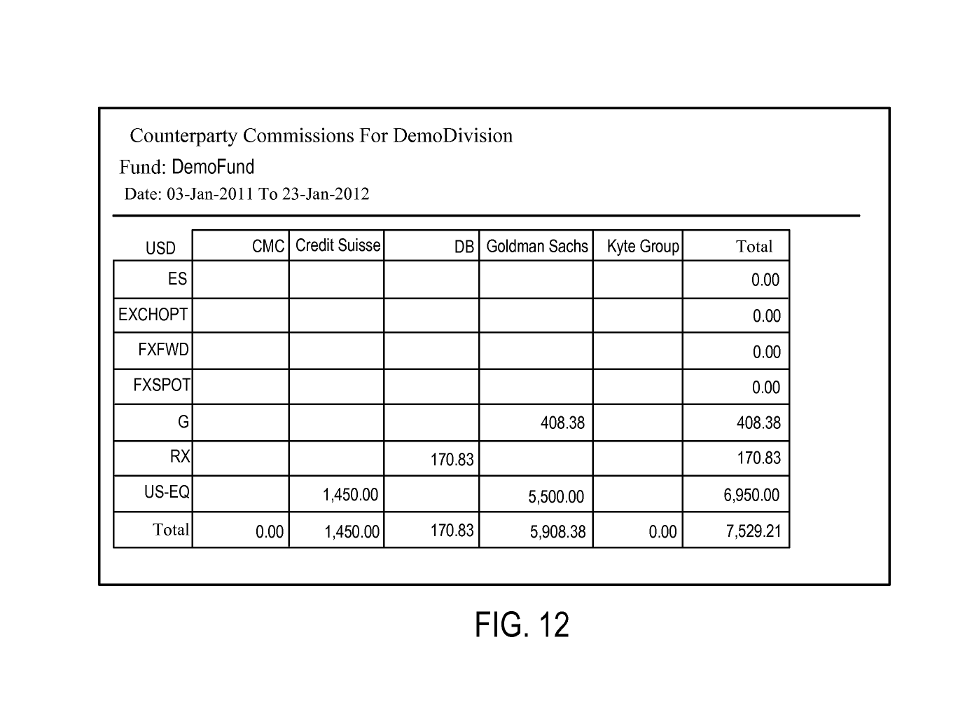

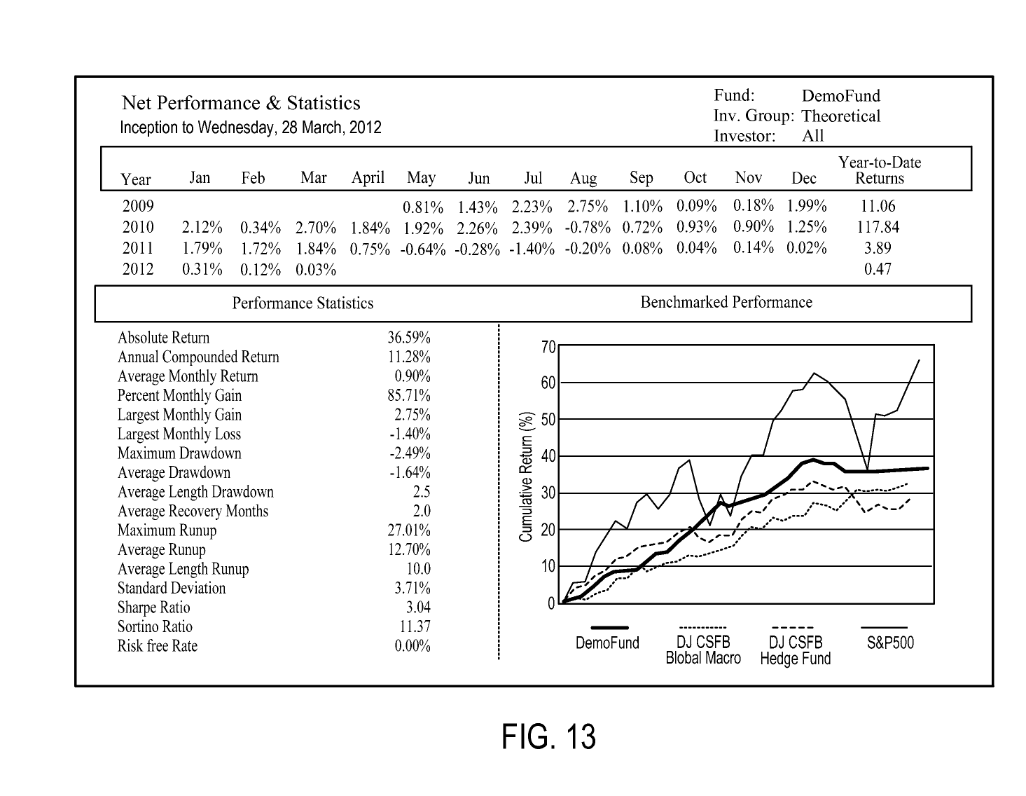

In some implementations, the platform 100 can generate commission and volume reports for monitoring execution and clearing counterparty relationships. FIG. 12 is an example commission report that shows commission earned by counterparty, including totals per party.

The reporting system of platform 100 may allow a user to track estimated NAVs in real-time as well as providing a mechanism for reconciling NAVs produced by an administrator or supervisor. The basis for the NAV calculation is the P/L generated from trading activities, to which fund investments and redemptions can be added as well as fees and expenses in order to generate NAVs on a theoretical basis. These NAVs can then be used to track fund performance over time and allows for the analysis of performance statistics such as drawdowns, run-ups, volatility and Sharpe ratios, among other measurements of performance.

The platform 100 allows for users to enter manual adjustments so that the reporting system NAV estimation may be brought into line with official NAV calculations. The reporting system can be used as a real-time reference point to assist in performance measurement and investor relations. An example NAV report shown in FIG. 13 includes a listing of net monthly returns, performance statistics (e.g. absolute return, largest monthly gain, average length run-up), and a graph showing cumulative returns.

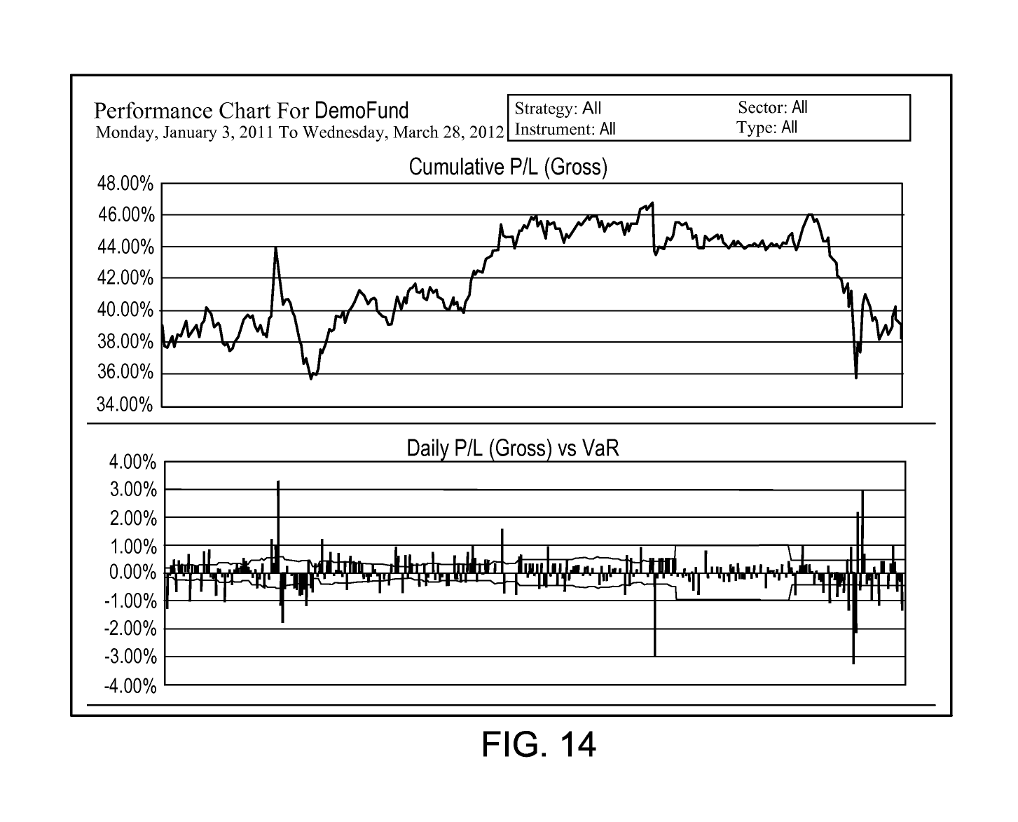

In some implementations, the platform 100 can produce charts that allow historic returns to be viewed graphically for an entire portfolio, by strategy, by sector or for a specific instrument. FIG. 14 is an example of a report produced by platform 100 that shows a daily performance chart tracking P/L and/or P/L vs. VaR.

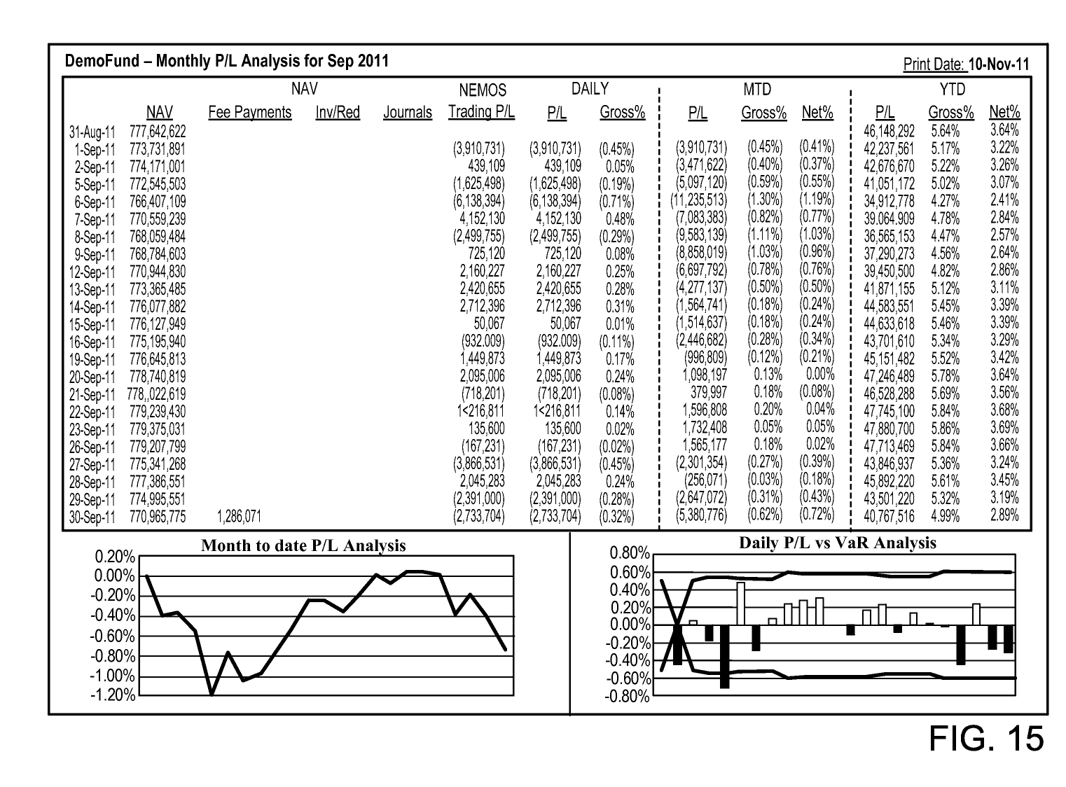

In some implementations, the platform 100 can generate monthly summaries that provide a picture of performance for a given month, including investments and redemptions, journals, P/L and return percentages on a gross and net basis. An example Monthly Performance Summary Report is shown in FIG. 15. The example report of FIG. 15 may show a listing of daily NaV, daily, weekly, month to date or year to date P/L, as well as graphs showing the same.

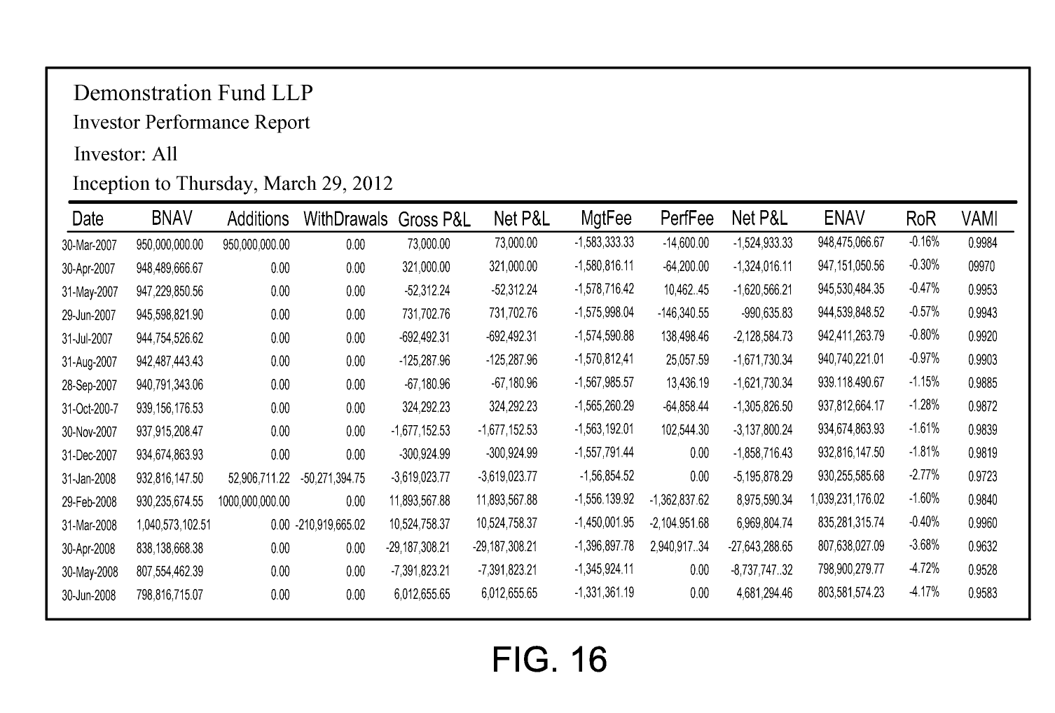

In some implementations, the platform 100 can provide more detailed performance reports for individual investors or for the fund as a whole over a specified time period. For instance, FIG. 16 is an example of a report entitled “Detailed Performance Report by Investor” and shows daily information such as additions, withdrawals, gross P/L, among other investor metrics.

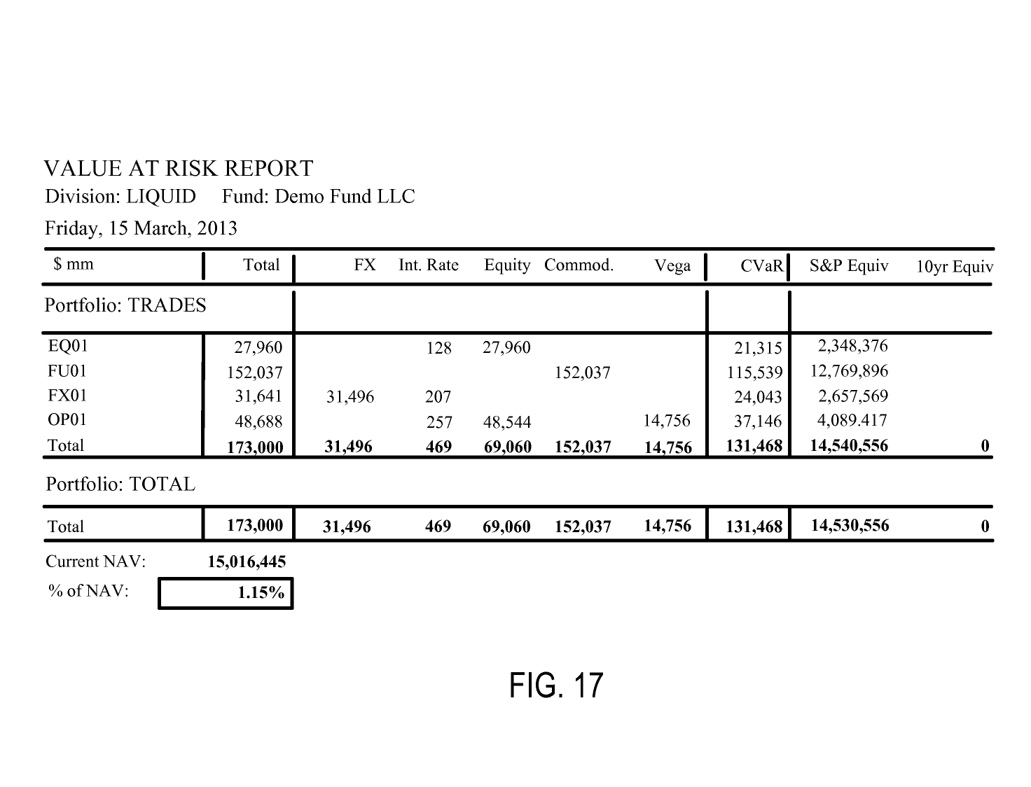

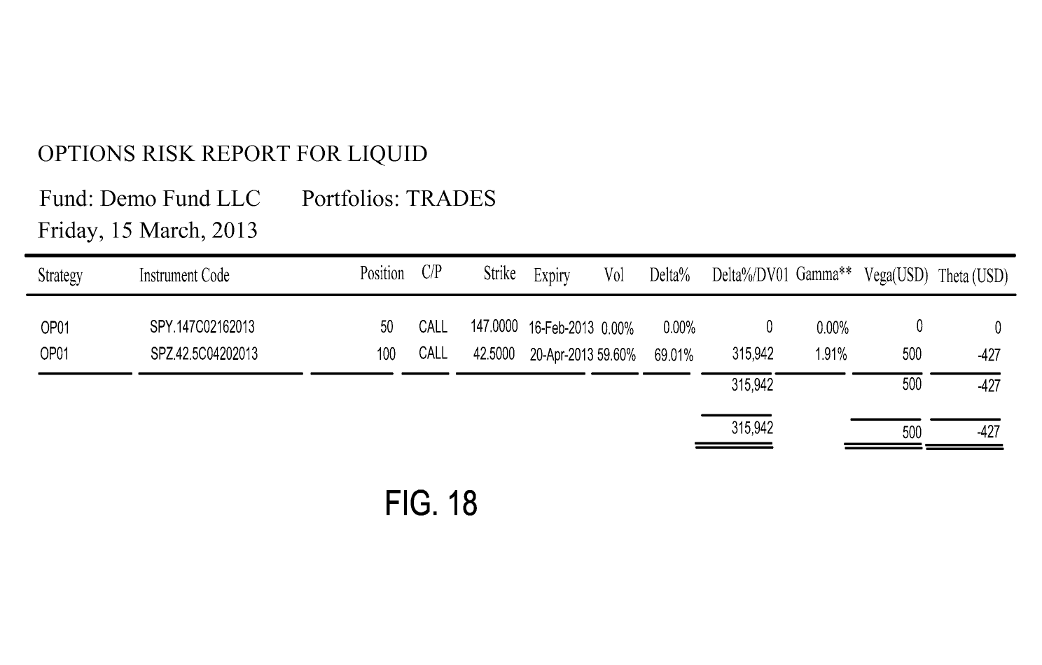

A key to a successful control environment is the application of a consistent, comprehensive and robust risk management framework. The foundation for this is a system that can capture and consolidate any and all trading/risk positions across a portfolio in a timely manner regardless of the format of risk in terms of asset class, geographical location and currency. A Value at Risk (VaR) by Strategy Report can show multiple portfolios with a VaR for each portfolio, with a total VaR for all portfolios. FIG. 17 is an example of a VaR report for a portfolio called “TRADES.” FIG. 18 is an example of an Options Risk report for options in the portfolio “TRADES.”

An example Fund Stress Report can show VaR at different standard deviations over different time periods, and the value at risk in historic shock scenarios.

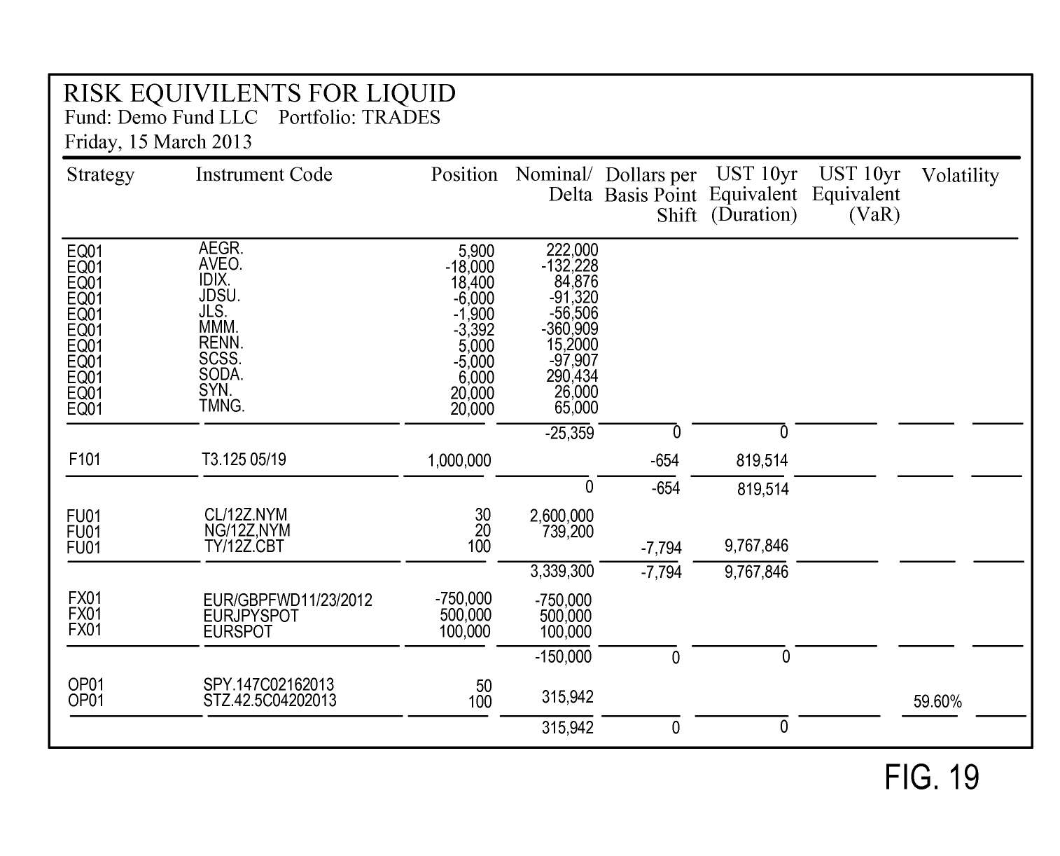

In addition to VaR and Stress Tests, the system calculates risk equivalent measures including USD (U.S. Dollar) values, DV01, Option Greeks, S&P and 10 year US Treasury equivalents (both duration and VaR weighted). For example, a hedging report can show a listing of strategies and their associated hedging metrics. FIG. 19 is an example of a risk equivalent report.

As well as managing trading positions, the reporting system also allows users to manage risks associated with residual currency balances held in currencies other than the base currency. For example, a Currency Balance by Date Report can show cash balances held in different currencies.

Hardware for Use with Electronic Financial Trading Platform

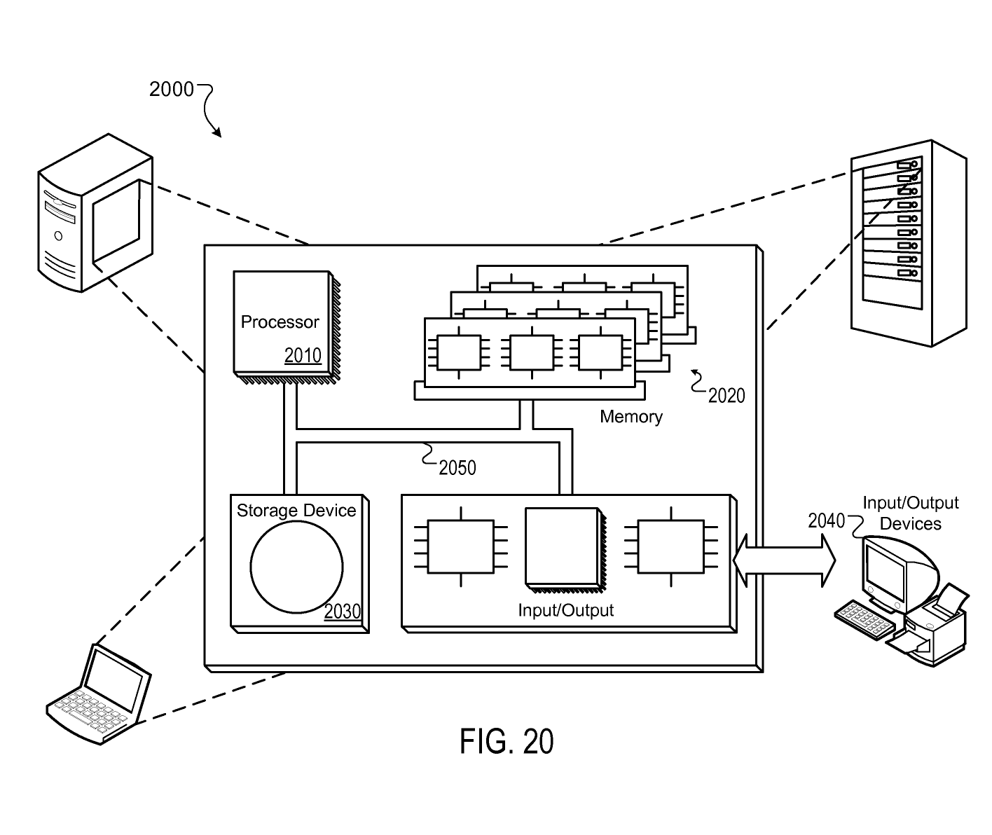

FIG. 20 is a schematic diagram that shows an example of a computing system 2000. The computing system 2000 can be used for some or all of the operations described previously, according to some implementations. For example, the computing system can be used for some or all of the operations of the electronic financial trading platform 100 shown in FIG. 1. The computing system 2000 includes a processor 2010, a memory 2020, a storage device 2030. The computing system 2000 may be coupled to an input/output device 2040. The client workstation shown in FIG. 1 corresponds to an example of an input/output device 2040. Each of the processor 2010, the memory 2020, and the storage device 2030 are interconnected using a system bus 2050. In some implementations, the input/output device 2040 also is connected to the system bus 2050. The processor 2010 is capable of processing instructions for execution within the computing system G00. In some implementations, the processor 2010 is a single-threaded processor. In some implementations, the processor 2010 is a multi-threaded processor. The processor 2010 is capable of processing instructions stored in the memory 2020 or on the storage device 2030 to display graphical information for a user interface on the input/output device 2040.

The memory 2020 stores information within the computing system 2000. In some implementations, the memory 2020 is a computer-readable medium. In some implementations, the memory 2020 is a volatile memory unit. In some implementations, the memory 2020 is a non-volatile memory unit.

The storage device 2030 is capable of providing mass storage for the computing system 2000. In some implementations, the storage device 2030 includes a computer-readable medium. In various different implementations, the storage device 2030 includes a floppy disk device, a hard disk device, an optical disk device, a flash drive device, or a tape device.

The input/output device 2040 provides input/output operations for the computing system 2000. In some implementations, the input/output device 2040 includes a keyboard and/or pointing device. In some implementations, the input/output device 2040 includes a display unit for displaying graphical user interfaces.

Some features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM (erasable programmable read-only memory), EEPROM (electrically erasable programmable read-only memory), and flash memory devices; magnetic disks such as internal hard disks and removable disks; magneto-optical disks; and CD-ROM (compact disc read-only memory) and DVD-ROM (digital versatile disc read-only memory) disks. The processor and the memory can be supplemented by, or incorporated in, ASICs (application-specific integrated circuits).

To provide for interaction with a user, some features can be implemented on a computer having a display device such as a CRT (cathode ray tube), LCD (liquid crystal display) monitor for displaying information to the user and a keyboard and a pointing device such as a mouse or a trackball by which the user can provide input to the computer. In some implementations, the display may be a touch-screen display.

Some features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN (local area network), a WAN (wide area network), and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

Other implementations are within the scope of the following claims.

What is claimed is:

1. An electronic financial trading platform comprising:
at least one application module;
a memory manager configured to provide normalized access to data content for the at least one application module, wherein the memory manager comprises
a storage model configured to store references to the data content,
an observer model configured to notify the at least one application module of changes to the storage model, and
an automation model configured to trigger one or more sets of processes by the at least one application module in response to changes in the storage model.

2. The electronic financial trading platform of claim 1, wherein the references to data content comprise a content object configured to provide a single normalized interface for a plurality of different data types.

3. The electronic financial trading platform of claim 2, wherein the plurality of different data types comprises at least two data types selected from the group consisting of: string, long, integer, double, boolean, and object.

4. The electronic financial trading platform of claim 1, wherein the observer model is configured to, in response to a change in the storage model:
review subscriptions to the storage model; and
issue a notification of the change to application modules that are subscribed to the storage model.

5. The electronic financial trading platform of claim 4, wherein the change in the storage model comprises a change in data content referenced by one or more cells of the storage model, and wherein the observer model is configured to, in response to the change in data content, issue the notification to application modules that are subscribed to the one or more cells of the storage model.

6. The electronic financial trading platform of claim 4, wherein the change in the storage model comprises a change in meta-data associated with one or more cells of the storage model, and wherein the observer model is configured to, in response to the change in meta-data, issue the notification to application modules that are subscribed to the to one or more cells.

7. The electronic financial trading platform of claim 4, wherein the observer model is operable to issue a content change notification and a meta-data change notification to the at least one application module in response to the change, and wherein the observer model is operable to synchronize the notifications.

8. The electronic financial trading platform of claim 1, wherein the automation model is configured to trigger the one or more sets of processes according to a dependency graph.

9. The electronic financial trading platform of claim 8, wherein the dependency graph comprises a plurality of nodes, each node corresponding to a different set of processes to be executed, wherein the order of the nodes is non-cyclical, and wherein execution of a set of processes represented by a first node in the graph begins after completion of a set of processes represented by a second node on which the first node depends.

10. The electronic financial trading platform of claim 9, wherein execution of a set of processes represented by a third node in the graph begins after completion of the set of processes represented by the second node, and wherein the sets of processes represented by the first and third nodes execute in parallel.

11. The electronic financial trading platform of claim 1, wherein the at least one application module is configured to:
examine one or more data elements to be transmitted;
for each data element, select a minimum sized data format from a plurality of data formats that can losslessly represent the respective data element; and
construct a message that contains the data elements in their respective minimum size data formats.

12. The electronic financial trading platform of claim 11, wherein the message comprises a control block to specify a number of bits required to represent a data element in the message.

13. The electronic financial trading platform of claim 12, wherein the at least one application module is configured to construct the message without delimiters between fields of the message.

14. The electronic financial trading platform of claim 13, wherein the message comprises a message count field for specifying a number of sub-messages contained with the message, and a field count field for identifying a number of fields within each sub-message.

15. The electronic financial trading platform of claim 14, wherein each sub-message comprises:
at least one type field to identify a data type of a value contained in the sub-message; and
at least one field identifier to identify a category of the value contained in the sub-message.

16. The electronic financial trading platform of claim 1, wherein the platform comprises one or more databases to store information relating to financial assets, and wherein the at least one application module is configured to:
receive, from one or more data sources, financial market data, wherein the financial market data comprises information about a plurality of financial assets;
perform a real-time analysis of at least one of the financial assets based on the marketplace data; and
generate information relating to results of the real-time analysis to the financial trading platform.

17. The electronic financial trading platform of claim 16, wherein the one or more databases are further configured to store market information relating to at least one pre-defined event scenario, and wherein the at least one application module is further configured to:
perform a simulation of a financial transaction based on the information relating to the at least one pre-defined event scenario; and
generate a report based on a result of the simulation.

18. The electronic financial trading platform of claim 1, wherein the at least one application module is further configured to
receive, from a client device, a command relating to a financial asset, wherein the command comprises an instruction to execute a financial transaction including the financial asset, an instruction to simulate a financial transaction including the financial asset, or an instruction to generate a report based on the at least one financial asset.

19. The electronic financial trading platform of claim 1, wherein the at least one application module is further configured to output one or more reports comprising the analysis of the at least one financial asset, wherein the one or more reports are selected from the group consisting of: a financial asset profitability report, a financial asset performance report, a financial asset risk evaluation report, and combinations thereof.

20. The electronic financial trading platform of claim 1, wherein the platform comprises:
a reporting module configured to generate reports based on one or more financial assets; and
a core trading module configured to execute and/or simulate one or more financial transactions based on one more financial assets.

21. A computer-implemented method comprising:
examining, in a first device, one or more data elements to be transmitted in a message;
for each data element, selecting a minimum sized data format from a plurality of data formats that can losslessly represent the data element; and
constructing a message that contains the data elements in their respective minimum size data formats.

22. The computer-implemented method of claim 21, wherein the message comprises a control block to specify a number of bits required to represent a data element in the message.

23. The computer-implemented method of claim 21, further comprising constructing the message without delimiters between fields of the message.

24. The computer-implemented method of claim 23, wherein the message comprises a message count field for specifying a number of sub-messages contained with the message, and a field count field for identifying a number of fields within each sub-message.

25. The computer-implemented method of claim 24, wherein each sub-message comprises:
at least one type field to identify a data type of a value contained in the sub-message; and
at least one field identifier to identify a category of the value contained in the sub-message.

26. The computer-implemented method of claim 21, further comprising transmitting the message to a second device.

27. A computer-implemented method comprising:
storing, in a storage model, a plurality of content objects, each content object referencing a corresponding data value;
receiving subscriptions to the storage model from one or more application modules;
reviewing, in response to a change in the storage model, the subscriptions to the storage model; and
issuing a notification of the change to an observer component of an application module that is subscribed to the storage model.

28. The computer-implemented method of claim 27, wherein the change in the storage model comprises a change in data content referenced by one or more cells of the storage model, and wherein the method comprises issuing the notification to an observer component of an application module that is subscribed to the one or more cells of the storage model.

29. The computer-implemented method of claim 27, wherein the change in the storage model comprises a change in meta-data associated with one or more cells of the storage model, and wherein the method comprises issuing the notification to an observer component of an application module that is subscribed to the to one or more cells.

30. The computer-implemented method of claim 27, wherein issuing the notification comprises issuing a content change notification and a meta-data change notification to the observer component of the application module, and wherein the notifications are synchronized.

31. The computer-implemented method of claim 27, further comprising triggering, in response to the change in the storage model, one or more sets of processes according to a dependency graph.

32. The computer-implemented method of claim 31, wherein the dependency graph comprises a plurality of nodes, each node corresponding to a different set of processes to be executed, wherein the order of the nodes is non-cyclical, and wherein execution of a set of processes represented by a first node in the graph begins after completion of a set of processes represented by a second node on which the first node depends.

33. The computer-implemented method of claim 32, wherein execution of a set of processes represented by a third node in the graph begins after completion of the set of processes represented by the second node, and wherein the sets of processes represented by the first and third nodes execute in parallel.
